(19) United States
(12) Patent Application Publication
(10) Pub. No.: US 2013/0282917 A1
(43) Pub. Date: Oct. 24, 2013

(54) METHOD AND APPARATUS FOR SMOOTH STREAM SWITCHING IN MPEG/3GPP-DASH

(71) Applicant: VID SCALE, INC., Wilmington, DE (US)

(72) Inventors: Yuriy Reznik, San Diego, CA (US); Eduardo Asbun, San Diego, CA (US); Zhifeng Chen, San Diego, CA (US); Rahul Vanam, San Diego, CA (US)

(21) Appl. No.: 13/868,968

(22) Filed: Apr. 23, 2013

Related U.S. Application Data
(60) Provisional application No. 61/637,777, filed on Apr. 24, 2012.

(51) Int. Cl. H04N 21/4402

(52) U.S. Cl. CPC H04N 21/4402
USPC 709/231

(57) ABSTRACT

A method and apparatus for providing smooth stream switching in video and/or audio encoding and decoding may be provided. Smooth stream switching may include the generation and/or display of one or more transition frames that may be utilized between streams of media content encoded at different rates. The transition frames may be generated via crossfading and overlapping, crossfading and transcoding, post-processing techniques using filtering, post-processing techniques using re-quantization, etc. Smooth stream switching may include receiving a first data stream of media content characterized by a first signal-to-noise ratio (SNR) and a second data stream of the media content characterized by a second SNR. Transition frames may be generated using at least one of frames of the first data stream and frames of the second data stream. The transition frames may be characterized by one or more SNR values that are between the first SNR and the second SNR.

### CROSS REFERENCE TO RELATED APPLICATIONS

This application claims the benefit of U.S. Provisional Patent Application No. 61/637,777, filed Apr. 24, 2012, the content/contents of which is/are hereby incorporated by reference herein.

### BACKGROUND

Streaming in wireless and wired networks may utilize adaptation due to variable bandwidth in a network. Content providers may publish content encoded at multiple rates and/or resolutions, which may enable clients to adapt to varying channel bandwidth. For example, Moving Picture Experts Group (MPEG) and third generation partnership project (3GPP) Dynamic Adaptive Streaming over Hypertext Transfer Protocol (HTTP) (DASH) standards may define a framework for the design of an end-to-end service that may enable efficient and high-quality delivery of streaming services over wireless and wired networks.

The DASH standard may define types of connections between streams, which may be referred to as stream access points (SAPs). Catenation of streams along SAPs may produce a correctly decodable MPEG stream. However, the DASH standard does not provide means or guidelines for ensuring invisibility of transitions between streams. If no special measures are applied, stream switches in DASH playback may be noticeable and may lead to decreased quality of experience (QoE) for the user. Changes in visual quality may be particularly noticeable when differences between rates are relatively large, and, for example, may be particularly noticeable when changing from a higher-quality stream to a lower-quality stream.

### SUMMARY

A method and apparatus for providing smooth stream switching in video and/or audio encoding and decoding may be provided. Smooth stream switching may include the generation and/or display of one or more transition frames that may be utilized between streams of media content encoded at different rates. The transition frames may be generated via crossfading and overlapping, crossfading and transcoding, post-processing techniques using filtering, post-processing techniques using re-quantization, etc.

Smooth stream switching may include receiving a first data stream of media content and a second data stream of media content. The media content may include video. The first data stream may be characterized by a first signal-to-noise ratio (SNR). The second data stream may be characterized by a second SNR. The first SNR may be greater than the second SNR, or the first SNR may be less than the second SNR.

Transition frames may be generated using at least one of frames of the first data stream characterized by the first SNR and frames of the second data stream characterized by the second SNR. The transition frames may be characterized by one or more SNR values that are between the first SNR and the second SNR. The transition frames may be characterized by a transition time interval. The transition frames may be part of one segment of the media content. One or more frames of the first data stream may be displayed, the transition frames may be displayed, and one or more frames of the second data stream may be displayed, for example, in that order.

Generating the transition frames may include crossfading the frames characterized by the first SNR with the frames characterized by the second SNR to generate the transition frames. Crossfading may include calculating a weighted average of the frames characterized by the first SNR and the frames characterized by the second SNR to generate the transition frames. The weighted average may changes over time. Crossfading may include calculating a weighted average of the frames characterized by the first SNR and the frames characterized by the second SNR by applying a first weight to the frames characterized by the first SNR and a second weight to the frames characterized by the second SNR. At least one of the first weight and the second weight may change over the transition time interval. Crossfading may be performed using a linear transition or a non-linear transition between the first date stream and the second data stream.

The first data stream and second data stream may include overlapping frames of the media content. Crossfading the frames characterized by the first SNR with the frames characterized by the second SNR to generate the transition frames may include crossfading the overlapping frames of the first data stream and the second data stream to generate the transition frames. The overlapping frames may be characterized by corresponding frames of the first data stream and of the second data stream. The overlapping frames may be characterized by an overlap time interval. One or more frames of the first data stream may be displayed before the overlap time interval, the transition frames may be displayed during the overlap time interval, and one or more frames of the second data stream may be displayed after the overlap time interval. The one or more frames of the first data stream may be characterized by times preceding the overlap time interval and the one or more frames of the second data stream may be characterized by times succeeding the overlap time interval.

A subset of frames of the first data stream may be transcoded to generate corresponding frames characterized by the second SNR. Crossfading the frames characterized by the first SNR with the frames characterized by the second SNR to generate the transition frames may include crossfading the subset of frames of the first data stream with the corresponding frames characterized by the second SNR to generate the transition frames.

Generating the transition frames may include filtering the frames characterized by the first SNR using a low-pass filter characterized by a cutoff frequency that changes over the transition time interval to generate the transition frames. Generating the transition frames may include transforming and quantizing the frames characterized by the first SNR using one or more of step sizes to generate the transition frames.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 is a diagram illustrating an example of a content encoded at different bitrates.

FIG. 3 is a diagram illustrating an example of bandwidth adaptive streaming.

FIG. 4 is a diagram illustrating an example of content encoded at different bitrates and partitioned into segments.

FIG. 5 is a diagram illustrating an example of an HTTP streaming session.

FIG. 6 is a diagram illustrating an example of a DASH high-level system architecture.

FIG. 7 is a diagram illustrating an example of a DASH client mode.

FIG. 8 is a diagram illustrating an example of a DASH media presentation high-level data model.

FIG. 9 is a diagram illustrating example parameters of a stream access point.

FIG. 10 is a diagram illustrating an example of a type 1 SAP.

FIG. 11 is a diagram illustrating an example of a type 2 SAP.

FIG. 12 is a diagram illustrating an example of a type 3 SAP.

FIG. 13 is a diagram illustrating an example of a Gradual Decoding Refresh (GDR).

FIG. 14 is a graph illustrating an example of transitions between rates during a streaming session.

FIG. 15 is a graph illustrating an example of transitions between trates during a streaming session having smooth transitions.

FIG. 16A is a diagram illustrating an example of transitions without smooth stream switching.

FIG. 16B is a diagram illustrating an example of transitions with smooth stream switching.

FIG. 17 is graphs illustrating examples of smooth streaming switching using overlapping and cross fading.

FIG. 18 is a diagram illustrating an example of system for overlapping and crossfading streams.

FIG. 19 is a diagram illustrating another example system for over lapping and crossfading streams.

FIG. 20 is graphs illustrating examples of smooth stream switching using transcoding and crossfading.

FIG. 21 is a diagram illustrating an example system for transcoding and crossfading.

FIG. 22 is a diagram illustrating another example system for transcoding and crossfading.

FIG. 23 is graphs illustrating examples of crossfading using linear transition between rates H and L.

FIG. 24 is a graph illustrating examples of non-linear crossfading functions.

FIG. 25 is a diagram illustrating an example system for crossfading scalable video bitstreams.

FIG. 26 is a diagram illustrating another example system for crossfading scalable video bitstreams.

FIG. 27 is a diagram illustrating an example of a system for progressive transcoding using QP crossfading.

FIG. 28 is graphs illustrating examples of smooth stream switching using post-processing.

FIG. 29 is a graph illustrating an example of frequency response of low-pass filters with different cutoff frequencies.

FIG. 30 is a diagram illustrating an example of smooth switching for streams with different frame resolutions.

FIG. 31 is a diagram illustrating an example of generating one or more transition frames for streams with different frame resolutions.

FIG. 32 is a diagram illustrating an example of a system for crossfading on H-L transition for streams with different frame resolutions.

FIG. 33 is a diagram illustrating an example of a system for crossfading on L-H transition for streams with different frame resolutions.

FIG. 34 is a diagram illustrating an example of a system for smooth switching for streams with different frame rates.

FIG. 35 is a diagram illustrating an example of generating one or more transition frames for streams with different frame rates.

FIG. 36 is a diagram illustrating an example system for crossfading on H-L transition for streams with different frame rates.

FIG. 37 is a diagram illustrating an example system for crossfading on L-H transition for streams with different frame rates.

FIG. 38 is a graph illustrating an example of overlap-add windows used in MDCT-based speech and audio codecs.

FIG. 39 is a diagram illustrating an example of an audio access point with a discardable block.

FIG. 40 is a diagram illustrating an example of an HE-ACC audio access point with three discardable blocks.

FIG. 41 is a diagram illustrating an example of a system for crossfading of audio streams in H-L transitions.

FIG. 42 is a diagram illustrating an example of a system for crossfading of audio streams in L-to-H transition.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

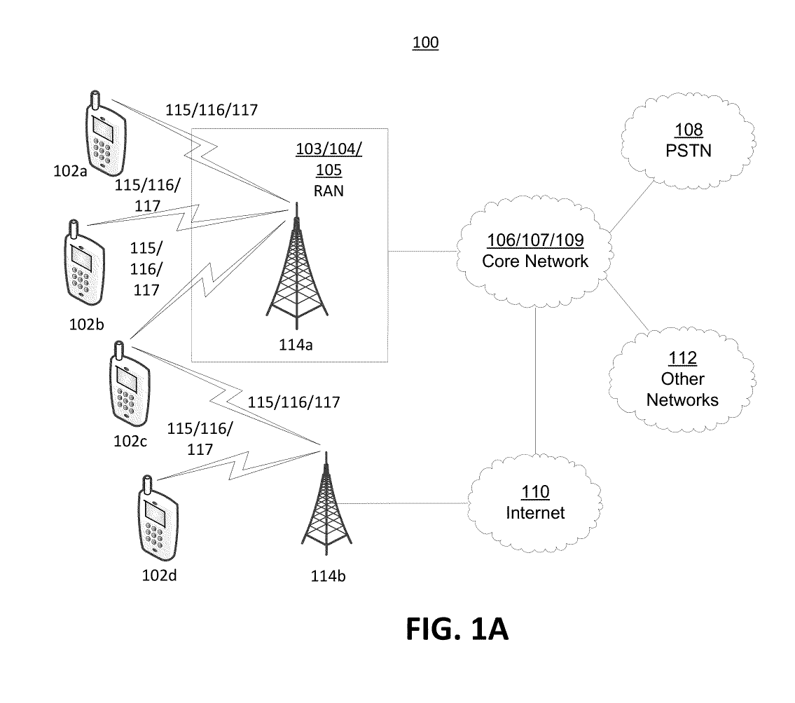

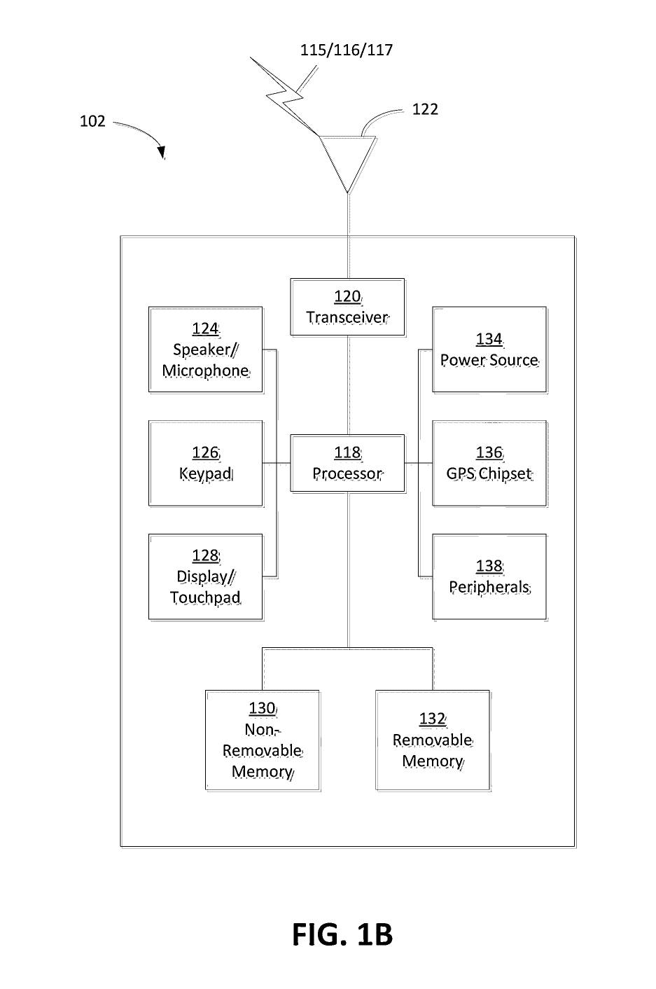

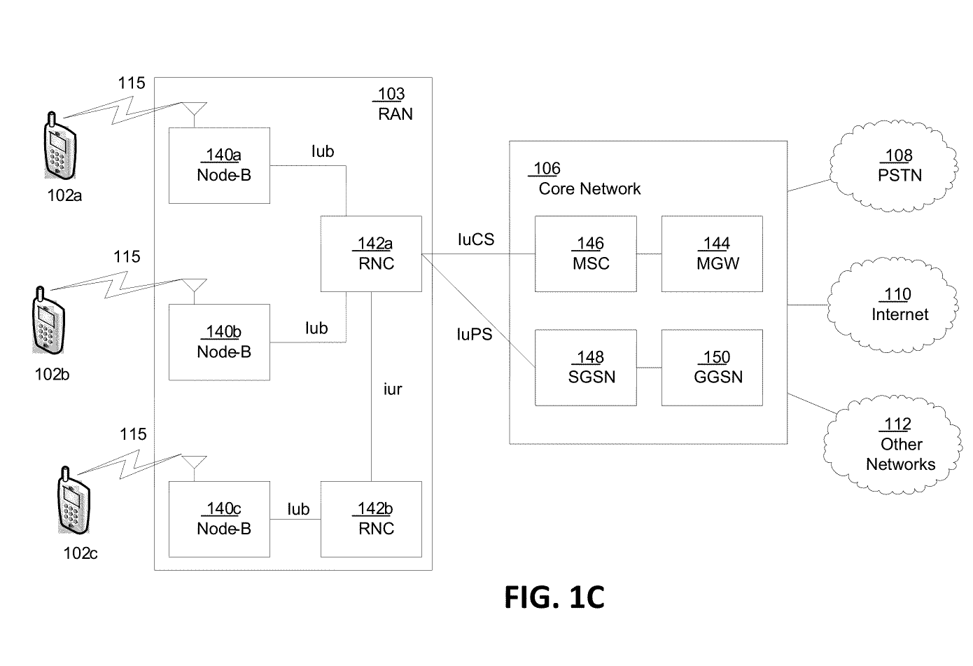

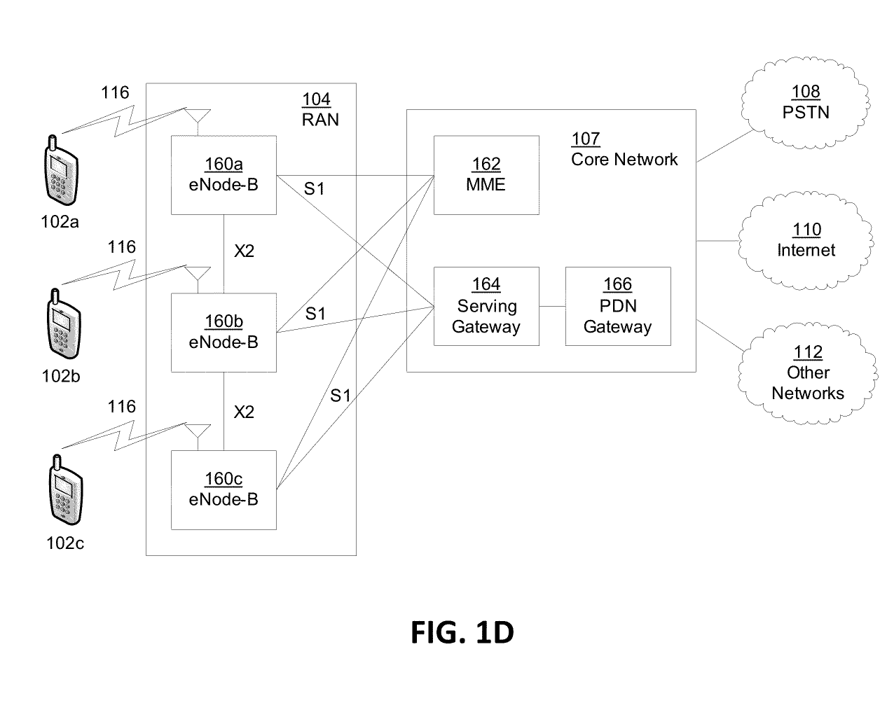

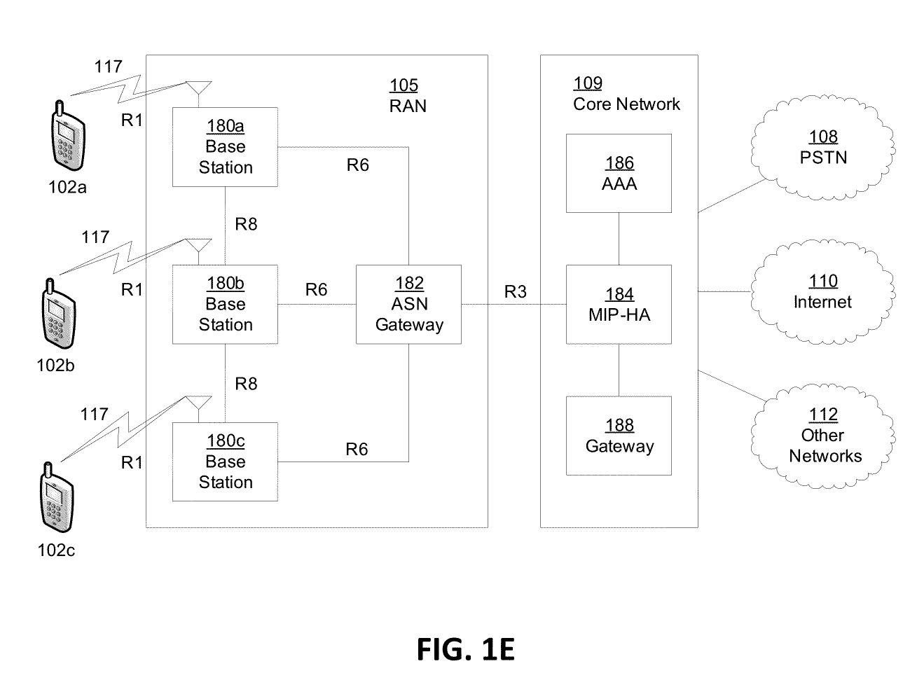

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Streaming in wired and wireless networks (e.g., 3 G, WiFi, Internet, the networks shown in FIGS. 1A-1E, etc.) may involve adaptation due to variable bandwidth in the network. For example, bandwidth adaptive streaming, where the rate at which media is streamed to clients may adapt to varying network conditions, may be utilized. Bandwidth adaptive streaming may enable a client (e.g., WTRU) to better match the rate at which the media is received to their own varying available bandwidth.

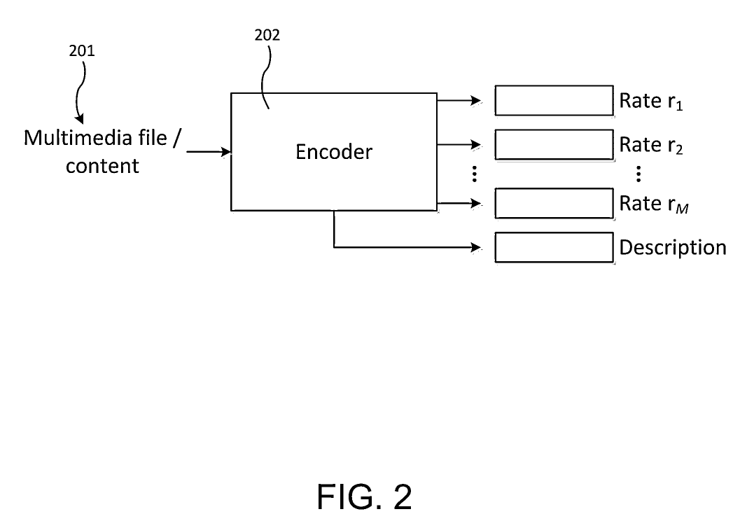

In a bandwidth adaptive streaming system, a content provider may offer the same content at one or more different bitrates, for example as shown in FIG. 2. FIG. 2 is a diagram illustrating an example of a content encoded at different bitrates. The content 201 may be encoded, for example, by an encoder 202, at a number of target bitrates (e.g., r1, r2, . . . , rM). To achieve these target bitrates, parameters such as a visual quality or SNR (e.g., video), a frame resolution (e.g., video), a frame rate (e.g., video), a sampling rate (e.g., audio), a number of channels (e.g., audio), or a codec (e.g., video and audio) may be changed. The description file (e.g., which may be referred to as a manifest file) may provide technical information and metadata associated with the content and its multiple representations, which may enable selection of the one or more different available rates.

Publishing of content at multiple rates may pose challenges, for example, an increase in production, quality assurance management, storage cost, etc. A number of rates/resolutions (e.g., three, four, five, etc.) may be made available.

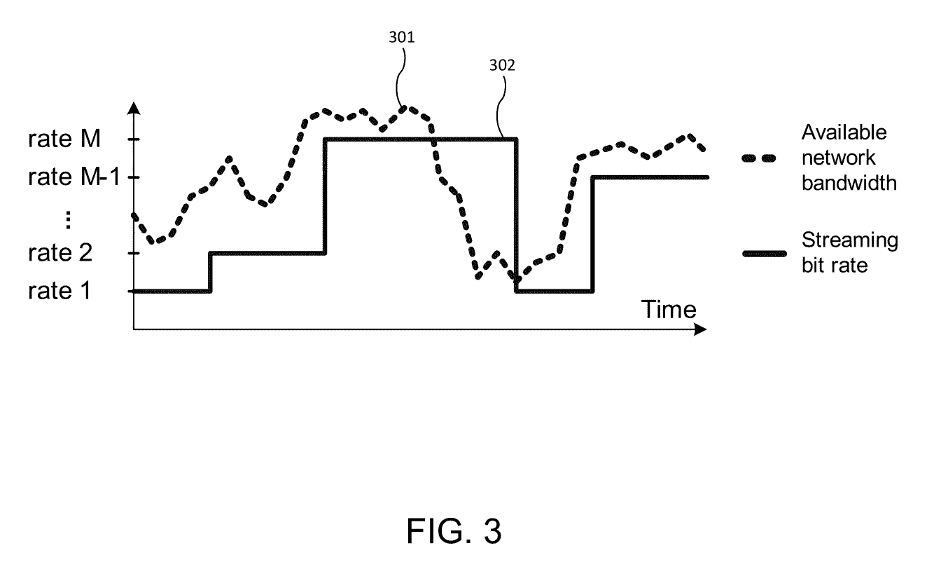

FIG. 3 is a diagram illustrating an example of bandwidth adaptive streaming. A multimedia streaming system may support bandwidth adaptation. A streaming media player (e.g., a streaming client) may learn about available bitrates from the media content description. A streaming client may measure and/or estimate the available bandwidth of the network 301 and control the streaming session by requesting segments of media content encoded at different bitrates 302. This may allow the streaming client to adapt to bandwidth fluctuations during playback of multimedia content, for example as shown in FIG. 3. A client may measure and/or estimate the available bandwidth based on one or more of buffer level, error rate, delay jitter, etc. A client may consider other factors, such as viewing conditions, when making decisions on which rates and/or segments to use, for example, in addition to bandwidth.

Stream switching behavior may be controlled by the server, for example, based on client or network feedback. This model may be used with streaming technologies based on RTP/RTSP protocols, for example.

Bandwidth of an access network may vary, for example, due to the underlying technology used (e.g., as shown in Table 1) and/or due to a number of users, location, signal strength, etc. Table 1 illustrates an example of peak bandwidth of an access network.

TABLE 1

| | | Example | |
|---|---|---|---|
| | | of Peak | |
| Access Technology | | Bandwidth | |
| Wireless | 2.5G | 32 | kbps |
| | 3G | 5 | Mbps |
| | LTE | 50 | Mbps |
| WiFi | 802.11b | 5 | Mbps |
| | 802.11g | 54 | Mbps |
| | 802.11n | 150 | Mbps |
| Internet | Dial-up | 64 | kbps |
| | DSL | 3 | Mbps |
| | Fiber | 1 | Gbps |

Content may be viewed on screens having different sizes, for example on smartphones, tablets, laptops, and larger screens such as HDTVs, for example. Table 2 illustrates an example of sample screen resolutions of various devices that may include multimedia streaming capabilities. Providing a small number of rates may not be enough to provide a good user experience to a variety of clients.

TABLE 2

| | |
|---|---|
| Device | Screen resolution |

| | | |
|---|---|---|
| Smartphones | HTC Desire | 800 × 480 |
| | iPhone | 960 × 640 |
| | Galaxy Nexus | 1280 × 720 |
| Tablets | Galaxy Tab | 1024 × 600 |
| | iPad 1, 2 | 1024 × 768 |
| | iPad 3 | 2048 × 1536 |
| Laptops | Notebook | 1024 × 600 |
| | Mid-range laptop | 1366 × 758 |
| | High-end laptop | 1920 × 1080 |
| HDTVs | 720p | 1280 × 720 |
| | 1080p | 1920 × 1080 |
| | 4K, Ultra HD | 4096 × 2160 |
| | (UHD) | |

An example of screen resolutions that may be utilized by the implementations described herein is listed in Table 3.

TABLE 3

| | |
|---|---|
| | Screen |
| Name(s) | resolution |

| | | |
|---|---|---|
| 240p | QVGA | 320 × 240 |
| 360 p | | 640 × 360 |
| 480p | VGA | 640 × 480 |
| 720p | | 1280 × 720 |
| 1080p | Full HD | 1920 × 1080 |
| 4K | Ultra HD (UHD) | 4096 × 2160 |

Content providers, such as YouTube®, iTunes®, Hulu®, etc., for example, may use HTTP progressive download to distribute multimedia content. HTTP progressive download may include content being downloaded (e.g., partially or fully) before it can be played back. Distribution using HTTP may be an internet transport protocol that may not be blocked by firewalls. Other protocols, such as RTP/RTSP or multicasting, for example, may be blocked by firewalls or disabled by internes service providers. Progressive download may not support bandwidth adaptation. Techniques for bandwidth adaptive multimedia streaming over HTTP may be developed for distributing live and on-demand content over packet networks.

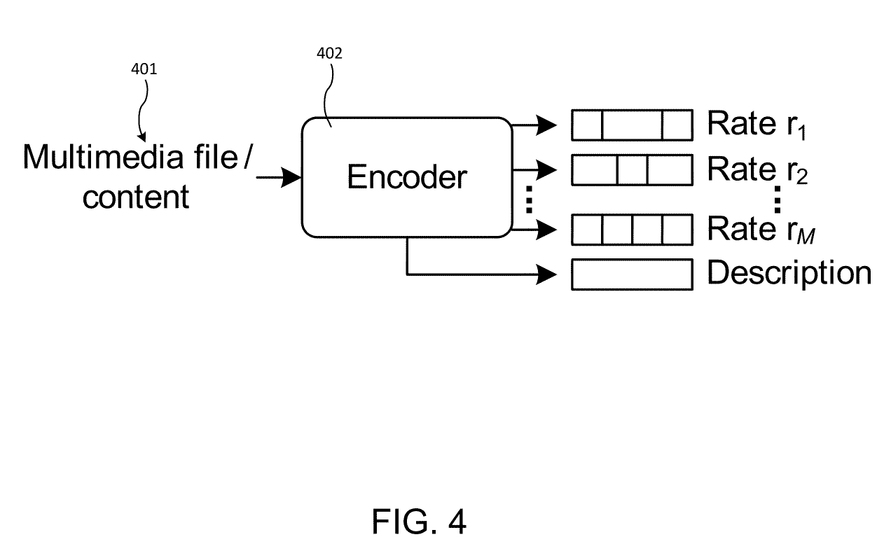

A media presentation may be encoded at one or more bitrates, for example, in bandwidth adaptive streaming over HTTP. An encoding of the media presentation may be partitioned into one or more segments of shorter duration, for example as shown in FIG. 4. FIG. 4 is a diagram illustrating an example of content 401 encoded by an encoder 402 at different bitrates and partitioned into segments. A client may use HTTP to request a segment at a bitrate that best matches their current conditions, for example, which may provide for rate adaptation.

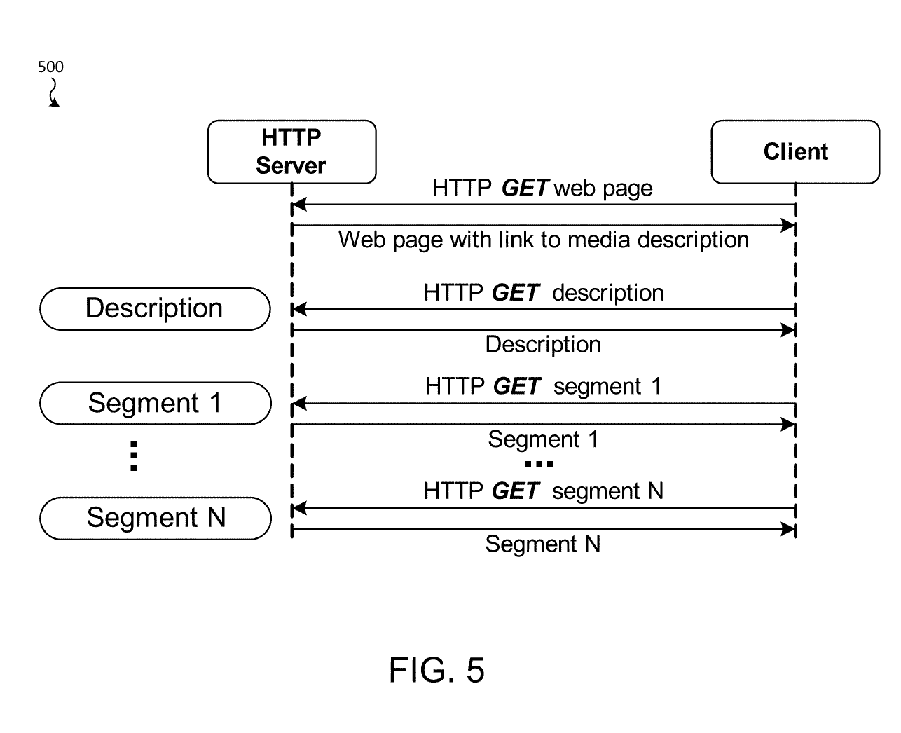

FIG. 5 is a diagram illustrating an example of an HTTP streaming session 500. For example, FIG. 5 may illustrate an example sequence of interactions between a client and an HTTP server during a streaming session. A description/manifest file and one or more streaming segments may be obtained by means of HTTP GET requests. The description/manifest file may specify the locations of segments, for example, via URLs.

Bandwidth adaptive HTTP streaming techniques may include HTTP Live Streaming (HLS), Smooth Streaming, HTTP Dynamic Streaming, HTTP Adaptive Streaming (HAS), and Adaptive HTTP Streaming (AHS), for example.

Dynamic Adaptive HTTP Streaming (DASH) may consolidate several approaches for HTTP streaming. DASH may be used to cope with variable bandwidth in wireless and wired networks. DASH may be supported by a large number of content providers and devices.

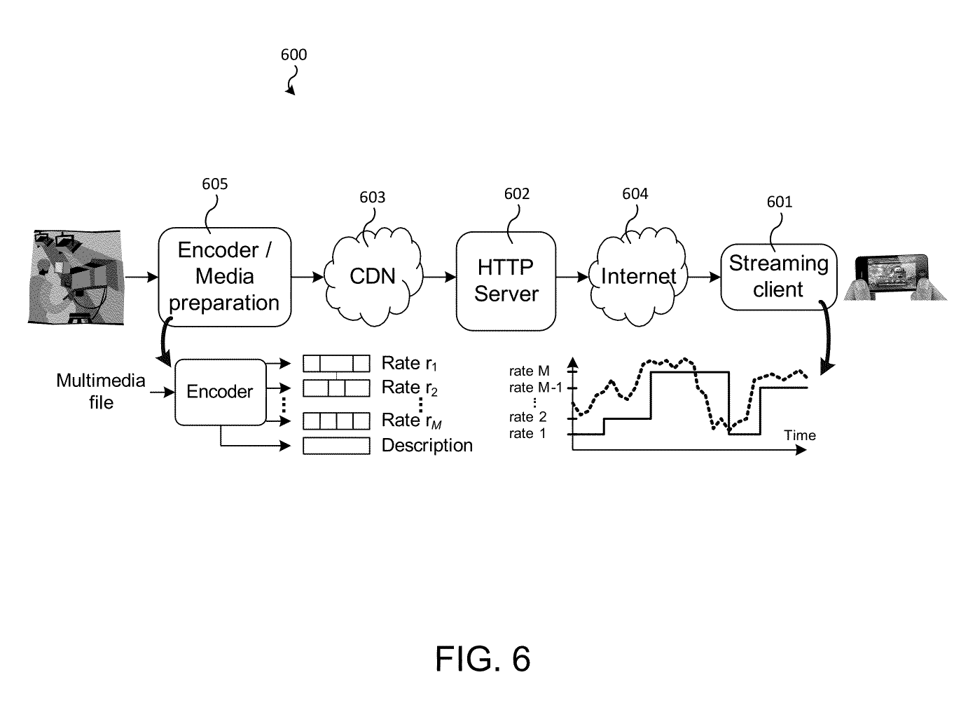

FIG. 6 is a diagram illustrating an example of a DASH high-level system architecture 600. DASH may be deployed as a set of HTTP servers 602 that distribute live or on-demand content 605 that has been prepared in a suitable format. A client 601 may access content directly from a DASH HTTP server 602 and/or from a Content Distribution Networks (CDN) 603, for example via the internet 604 as shown in FIG. 6. A CDN 603 may be used for deployments where a large number of clients are expected, for example, since a CDN may cache content and may be located near the clients at the edge of the network. A client 601 may be a WTRU and/or may reside on a WTRU, for example, a WTRU as shown in FIG. 1B. The CDN 603 may comprise one or more of the elements shown in FIGS. 1A-1E.

In DASH, the streaming session may be controlled by the client 601 by requesting segments using HTTP and splicing the segments together as they are received from the content provider and/or CDN 603. A client 601 may monitor (e.g., continually monitor) and adjust media rate, for example, based on network conditions (e.g., packet error rate, delay jitter, etc.) and/or the state of the client 601 (e.g., buffer fullness, user behavior and preferences, etc.), for example, to effectively move intelligence from the network to the client 601.

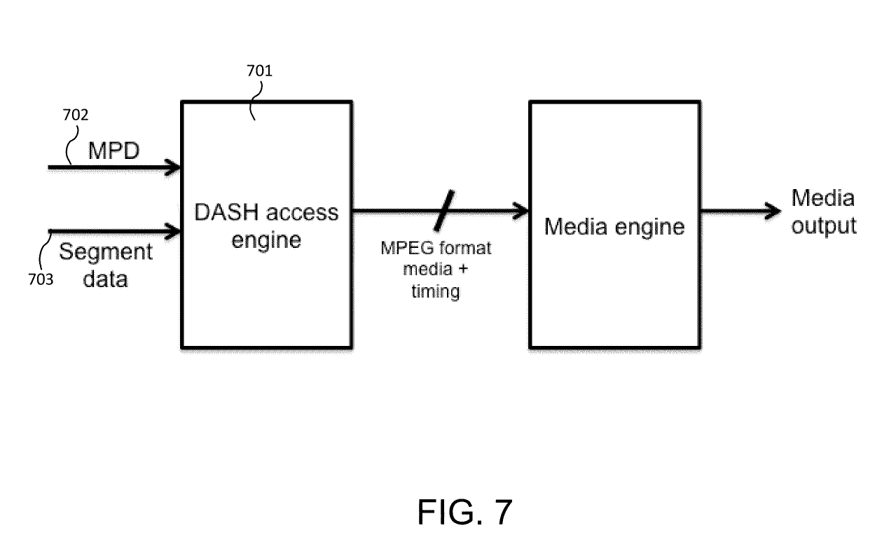

FIG. 7 is a diagram illustrating an example of a DASH client mode. The DASH client mode may be based on an informative client model. The DASH Access Engine 701 may receive a media presentation description (MPD) file 702, construct and issue a request, and/or and receive one or more segments and/or parts of segments 703. The output of the DASH Access Engine 701 may include media in an MPEG container format (e.g., MP4 File Format or MPEG-2 Transport Stream), for example, with timing information that maps the internal timing of the media to the timeline of the presentation. The combination of encoded chunks of media with timing information may be sufficient for correct rendering of the content.

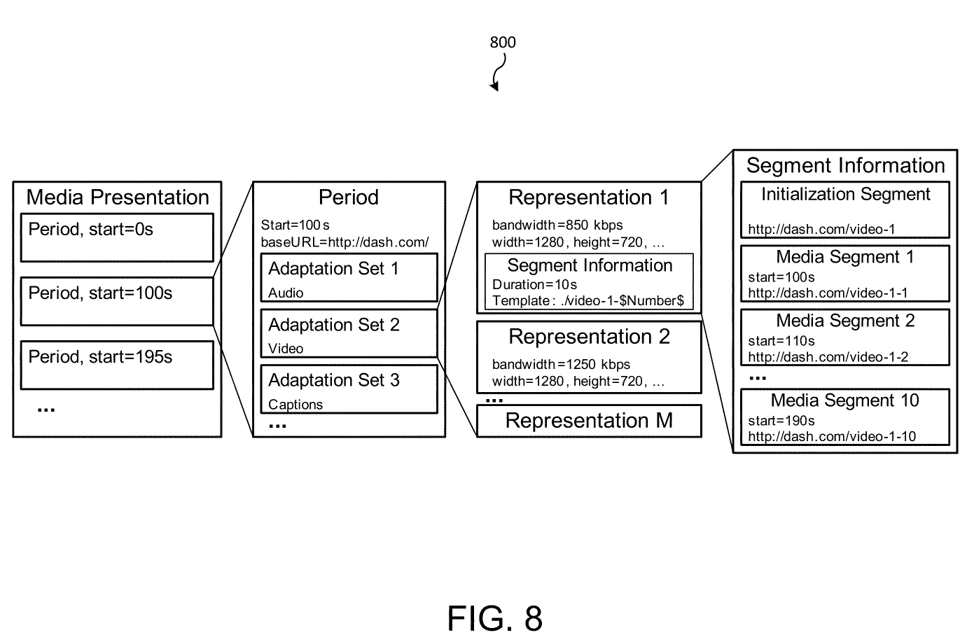

FIG. 8 is a diagram illustrating an example of a DASH media presentation high-level data model 800. In DASH, the organization of a multimedia presentation may be based on a hierarchical data model, for example as shown in FIG. 8. A MPD file may describe a sequence of periods that may make up a DASH media presentation (e.g., the multimedia content). A period may refer to a media content period during which a consistent set of encoded versions of the media content may be available. For example, a set of available bitrates, languages, captions, etc. may not change during a period.

An adaptation set may refer to a set of interchangeable encoded versions of one or more media content components. For example, there may be an adaptation set for video, for primary audio, for secondary audio, for captions, etc. An adaptation set may be multiplexed. Interchangeable versions of the multiplex may be described as a single adaptation set. For example, an adaptation set may include both video and main audio for a period.

A representation may refer to a deliverable encoded version of one or more media content components. A representation may include one or more media streams (e.g., one for each media content component in the multiplex). A representation within an adaptation set may be sufficient to render the media content components. A client may switch from representation to representation within an adaptation set in order to adapt to network conditions and/or other factors. A client may ignore a representation that use codecs, profiles, and/or parameters that the client does not support.

Content within a representation may be divided in time into one or more segments of fixed or variable length. A URL may be provided for a segment (e.g., for each segment). A segment may be the largest unit of data that can be retrieved with a single HTTP request.

The Media Presentation Description (MPD) file may be an XML document that includes metadata that may be used by a DASH client to construct appropriate HTTP-URLs to access one or more segments and/or to provide the streaming service to the user. A base URL in the MPD file may be used by the client to generate HTTP GET requests for one or more segments and/or other resources in the Media Presentation. HTTP partial GET requests may be used to access a limited portion of a segment, for example, by using a byte range (e.g., via the ‘Range’ HTTP header). Alternative base URLs may be specified to allow access to the presentation in case a location is unavailable. Alternative base URLs may provide redundancy to the delivery of multimedia streams, for example, which may allow client-side load balancing and/or parallel download.

An MPD file may be of type static or dynamic. A static MPD file type may not change during the Media Presentation. A static MPD file may be used for on demand presentations. A dynamic MPD file type may be updated during the Media Presentation. A dynamic MPD file type may be used for live presentations. An MPD file may be updated, for example to extend the list of segments for a representation, to introduce a new period, to terminate the Media Presentation, and/or to process or adjust a timeline.

In DASH, encoded versions of different media content components (e.g., video, audio) may share a common timeline. The presentation time of access units within the media content may be mapped to a global common presentation timeline, which may be referred to as a media presentation timeline. The media presentation timeline may allow for synchronization of different media components. The media presentation timeline may enable seamless switching of different coded versions (e.g., Representations) of the same media components.

A segment may include the actual segmented media streams. A segment may include additional information relating to how to map a media stream into the media presentation timeline, for example, for switching and synchronous presentation with other representations.

A segment availability timeline may be used to signal clients the availability time of one or more segments at a specified HTTP URL. The availability time may be provided in wall-clock times. A client may compare the wall-clock time to a segment availability time, for example, before accessing the segments at the specified HTTP URL.

The availability time of one or more segments may be identical, for example, for on-demand content. Segments of the media presentation (e.g., all segments) may be available on the server once one of the segments is available. The MPD file may be a static document.

The availability time of one or more segments may depend on the position of the segment in the media presentation timeline, for example, for live content. A segment may become available with time as the content is produced. The MPD file may be updated (e.g., periodically) to reflect changes in the presentation over time. For example, one or more segment URLs for one or more new segments may be added to the MPD file. Segments that are no longer available may be removed from the MPD file. Updating the MPD file may not be necessary, for example, if segment URLs are described using a template.

The duration of a segment may represent the duration of the media included in the segment, for example, when presented at normal speed. The segments in a representation may have the same or roughly the same duration. Segment duration may differ from representation to representation. A DASH presentation may be constructed with one or more short segments (e.g., 2-8 seconds) and/or one or more longer segments. A DASH presentation may include a single segment for the entire representation.

Short segments may be suitable for live content (e.g., by reducing end-to-end latency) and may allow for high switching granularity at the segment level. Long segments may improve cache performance by reducing the number of files in the presentation. Long segments may enable a client to make flexible request sizes, for example, by using byte range requests. The use of long segments may compel the use of a segment index.

A segment may not be extended over time. A segment may be a complete and discrete unit that may be made available in its entirety. A segment may be referred to as a movie fragment. A segment may be subdivided into sub-segments. A sub-segment may include a whole number of complete access units. An access unit may be a unit of a media stream with an assigned media presentation time. If a segment is divided into one or more sub-segments, then the segment may be described by a segment index. The segment index may provide the presentation time range in the representation and/or corresponding byte range in the segment occupied by each sub-segment. A client may download the segment index in advance. A client may issue requests for individual sub-segments using HTTP partial GET requests. The segment index may be included in a media segment, for example, in the beginning of the file. Segment index information may be provided in one or more index segments (e.g., separate index segments).

DASH may utilize a plurality (e.g., four) types of segment. The types of segments may include initialization segments, media segments, index segments, and/or bitstream switching segments. Initialization segments may include initialization information for accessing a representation. Initialization segments may not include media data with an assigned presentation time. An initialization segment may be processed by the client to initialize the media engines for enabling play-out of a media segment of the included representation.

A media segment may include and/or encapsulate one or more media streams that may be described within this media segment and/or described by the initialization segment of the representation. A media segment may include one or more complete access units. A media segment may include at least one Stream Access Point (SAP), for example, for each included media stream.

An index segment may include information that is related to one or more media segments. An index segment may include indexing information for one or more media segments. An index segment may provide information for one or more media segments. An index segment may be media format specific. More details may be defined for a media format that supports an index segment.

A bitstream switching segment may include data for switching to its assigned representation. A bitstream switching segment may be media format specific. More details may be defined for each media format that supports bitstream switching segments. One bitstream switching segment may be defined for each representation.

A client may switch from representation to representation within an adaptation set, for example, at any point in the media. Switching at arbitrary positions may be complicated, for example, because of coding dependencies within representations. The download of overlapping data, for example, media for the same time period from multiple representations, may be performed. Switching may be performed at a random access point in a new stream.

DASH may define a codec-independent concept of a stream access point (SAP) and/or may identify one or more types of SAPs. A stream access point type may be communicated as one of the properties of the adaptation set, for example, assuming that all segments within an adaptation set have same SAP type. A SAP may enable random access into a file container of one or more media streams. A SAP may be a position in a container enabling playback of an identified media stream to be started, for example, using the information included in the container starting from that position onwards. Initialization data from other parts of the container and/or that may be externally available may be used. A SAP may be a connection between streams, for example, within DASH. For example, a SAP may be characterized by a position within a representation where a client may switch into the representation, for example, from another representation. A SAP may ensure that catenation of streams along SAPs may produce a correctly decodable data stream (e.g., MPEG stream).

T_{SAP} may be the earliest presentation time of any access unit of the media stream, for example, such that access units of a media stream with a presentation time greater than or equal to T_{SAP} may be correctly decoded using data in the bitstream starting at I_{SAP} and no data before I_{SAP}. I_{SAP} may be the greatest position in the bitstream, for example, such that access units of the media stream with a presentation time greater than or equal to T_{SAP} may be correctly decoded using bitstream data starting at I_{SAP} and no data before I_{SAP}. I_{SAU} may be the starting position in the bitstream of the latest access unit in decoding order within the media stream, for example, such that access units of the media stream with presentation time greater than or equal to T_{SAP} may be correctly decoded using the latest access unit and access units following in decoding order, and no access units earlier in the decoding order.

T_{DEC} may be the earliest presentation time of an access unit of the media stream that may be correctly decoded using data in the bitstream starting at I_{SAU} and without any data before I_{SAU}. T_{EPT} may be the earliest presentation time of an access unit of the media stream starting at I_{SAU} in the bitstream. T_{PTF} may be the presentation time of the first access unit of the media stream in decoding order in the bitstream starting at I_{SAU}.

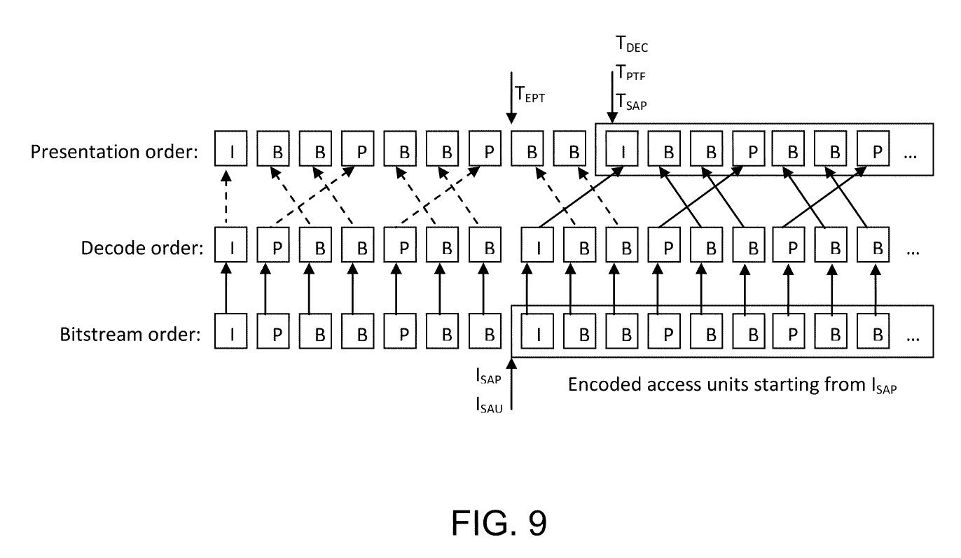

FIG. 9 is a diagram illustrating example parameters of a stream access point (SAP). The example of FIG. 9 illustrates an example of an encoded video stream with three different types of frames: I frames, P frames, and B frames. P frames may utilize prior 1 or P frames to be decoded. B frames may utilize prior and following I or P frames. There may be differences in the transmission, decoding, and/or presentation orders of I frames, P frames, and/or B frames.

A plurality (e.g., six) SAP types may be defined. The use of different SAP types may be limited based on profile. For example, SAPs of types 1, 2, and 3 may be allowed for some profiles. The type of SAP may depend on which access units may be correctly decodable and/or the arrangement in the presentation order of the access units.

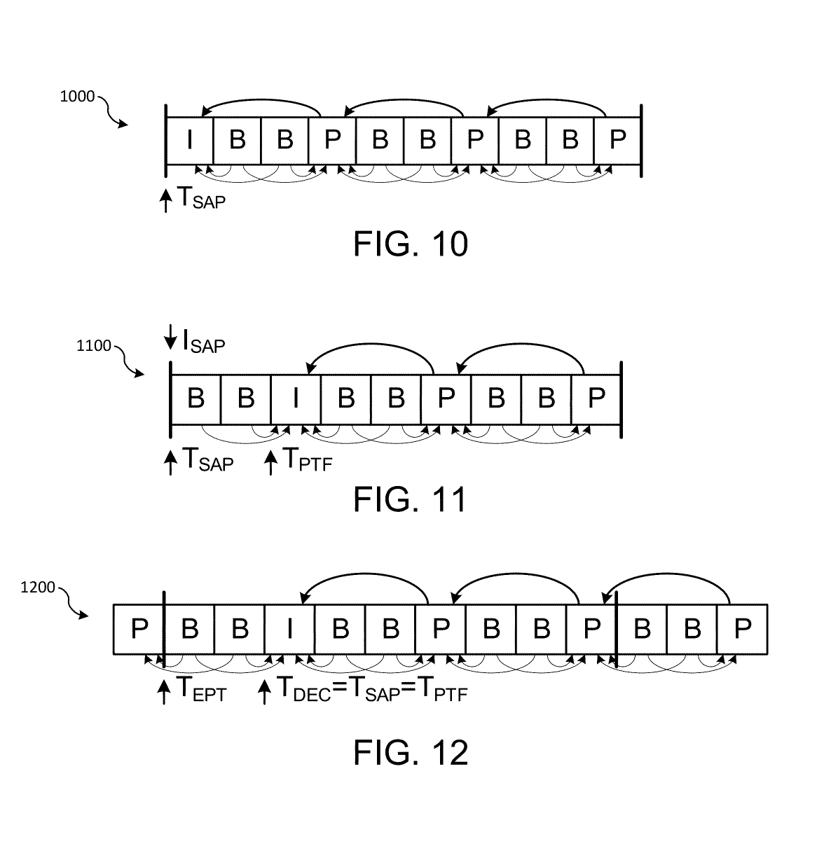

FIG. 10 is a diagram illustrating an example of a type 1 SAP 1000. A type 1 SAP may be described by the following: T_{EPT}=T_{DEC}=T_{SAP}=T_{PFT}. A type 1 SAP may correspond to and/or be referred to as a “Closed GoP random access point.” Access units (e.g., in decoding order) starting from I_{SAP} may be correctly decoded in a type 1 SAP. The result may be a continuous time sequence of correctly decoded access units without any gaps. The first access unit in the decoding order may be the first access unit in a presentation order.

FIG. 11 is a diagram illustrating an example of a type 2 SAP 1100. A type 2 SAP may be described by the following: T_{EPT}=T_{DEC}=T_{SAP}<T_{PFT}. A type 2 SAP may correspond to and/or be referred to as a “Closed GoP random access point,” for example, in which the first access unit in the decoding order in the media stream starting from I_{SAU} may not be the first access unit in the presentation order. The first frames (e.g., first two frames) may be backward predicted P frames (e.g., which may be syntactically coded as forward-only B-frames), and may utilize a subsequent frame (e.g., the third frame) to be decoded.

FIG. 12 is a diagram illustrating an example of a type 3 SAP 1200. A type 3 SAP may be described by the following: T_{EPT}<T_{DEC}=T_{SAP}<=T_{PTF}. A type 3 SAP may correspond to and/or be referred to as an “Open GoP random access point,” for example, in which there may be access units in the decoding order following I_{SAU} that may not be correctly decoded and/or may have presentation times that are less than T_{SAP}.

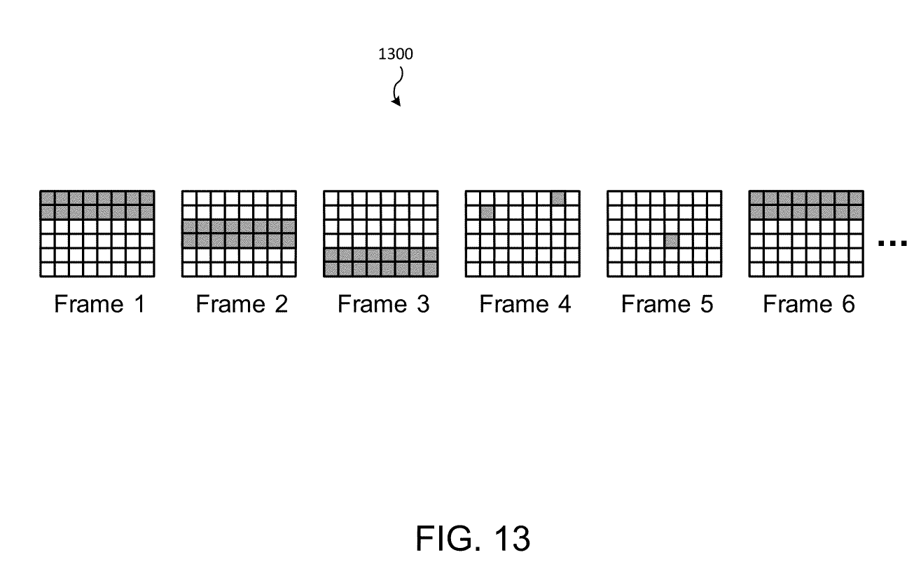

FIG. 13 is a diagram illustrating an example of a Gradual Decoding Refresh (GDR) 1300 with a duration of three frames and an interval of six frames. The type 4 SAP may be described by the following: T_{EPT}<=T_{PFT}<T_{DEC}=T_{SAP}. The type 4 SAP may correspond to and/or be referred to as a “Gradual Decoding Refresh (GDR) random access point” (e.g., a “dirty” random access), for example, in which there may be access units in the decoding order starting from and following I_{SAU} that may not be correctly decoded and/or may have presentation times less than T_{SAP}.

An example of a GDR may be the intra refreshing process, which may be extended over N frames, and where part of a frame may be coded with intra macroblocks (MBs). Non-overlapping parts may be intra coded across N frames. This process may be repeated until the entire frame is refreshed.

A type 5 SAP may be described by the following: T_{EPT}=T_{DEC}<T_{SAP}. The type 5 SAP may correspond to a case in which there may be at least one access unit in the decoding order starting from I_{SAP} that cannot be correctly decoded and/or may have a presentation time that is greater than T_{DEC}, and/or where T_{EC} may be the earliest presentation time of an access unit starting from I_{SAU}.

A type 6 SAP may be described by the following: T_{EPT}<T_{DEC}<T_{SAP}. The type 6 SAP may correspond to a case in which there may be at least one access unit in the decoding order starting from I_{SAP} that may not be correctly decoded and/or may have a presentation time that is greater than T_{DEC}, and where T_{DEC} may not be the earliest presentation time of an access unit starting from I_{SAU}. The type 4, 5, and/or 6 SAPs may be utilized in a case of handling transitions in audio coding.

Smooth stream switching in video and/or audio encoding and decoding may be provided. Smooth stream switching may include the generation and/or display of one or more transition frames that may be utilized between streams (e.g., portions of a stream) of media content encoded at different rates. The transition frames may be generated via crossfading and overlapping, crossfading and transcoding, post-processing techniques using filtering, post-processing techniques using re-quantization, etc.

Smooth stream switching may include receiving a first data stream of media content and a second data stream of media content. The media content may include video and/or audio. The media content may be in an MPEG container format. The first data stream and/or the second data stream may be identified in a MPD file. The first data stream may be an encoded data stream. The second data stream may be an encoded data stream. The first data stream and the second data stream may be portions of the same data stream. For example, the first data stream may temporally proceed (e.g., immediately proceed) the second data stream. For example, the first data stream and/or the second data stream may begin and/or end at a SAP of the media content.

The first data stream may be characterized by a first signal-to-noise ratio (SNR). The second data stream may be characterized by a second SNR. For example, the first SNR and the second SNR may relate to the encoding of the first data stream and the second data stream, respectively. The first SNR may be greater than the second SNR, or the first SNR may be less than the second SNR.

Transition frames may be generated using at least one of frames of the first data stream and frames of the second data stream. The transition frames may be characterized by one or more SNR values that are between the first SNR and the second SNR. The transition frames may be characterized by a transition time interval. The transition frames may be part of one segment of the media content. One or more frames of the first data stream may be displayed, the transition frames may be displayed, and one or more frames of the second data stream may be displayed, for example, in that order. The switch from the first data stream to the transition frames and/or from the transition frames to the second data stream may be done at a SAP of the media content.

Generating the transition frames may include crossfading the frames characterized by the first SNR with the frames characterized by the second SNR to generate the transition frames. Crossfading may include calculating a weighted average of the frames characterized by the first SNR and the frames characterized by the second SNR to generate the transition frames. The weighted average may changes over time. Crossfading may include calculating a weighted average of the frames characterized by the first SNR and the frames characterized by the second SNR by applying a first weight to the frames characterized by the first SNR and a second weight to the frames characterized by the second SNR. At least one of the first weight and the second weight may change over the transition time interval. Crossfading may be performed using a linear transition or a non-linear transition between the first date stream and the second data stream.

The first data stream and second data stream may include overlapping frames of the media content. Crossfading the frames characterized by the first SNR with the frames characterized by the second SNR to generate the transition frames may include crossfading the overlapping frames of the first data stream and the second data stream to generate the transition frames. The overlapping frames may be characterized by corresponding frames of the first data stream and of the second data stream. The overlapping frames may be characterized by an overlap time interval. One or more frames of the first data stream may be displayed before the overlap time interval, the transition frames may be displayed during the overlap time interval, and one or more frames of the second data stream may be displayed after the overlap time interval. The one or more frames of the first data stream may be characterized by times preceding the overlap time interval and the one or more frames of the second data stream may be characterized by times succeeding the overlap time interval.

A subset of frames of the first data stream may be transcoded to generate corresponding frames characterized by the second SNR. Crossfading the frames characterized by the first SNR with the frames characterized by the second SNR to generate the transition frames may include crossfading the subset of frames of the first data stream with the corresponding frames characterized by the second SNR to generate the transition frames.

Generating the transition frames may include filtering the frames characterized by the first SNR using a low-pass filter characterized by a cutoff frequency that changes over the transition time interval to generate the transition frames. Generating the transition frames may include transforming and quantizing the frames characterized by the first SNR using one or more of step sizes to generate the transition frames.

One or more parameters of media content (e.g., a video sequence) may be controlled during encoding to effect changes in the bitrate of the encoded media content. For example, the parameters may include, but are not limited to signal-to-noise ratio (SNR), frame resolution, frame rate, etc. The SNR of media content may be controlled during encoding to generate encoded versions of the media content with varying bitrates. For example, the SNR may be controlled via a quantization parameter (QP) used on transform coefficients during encoding. For example, changing the QP may affect the SNR (e.g., and bitrate) of an encoded video sequence. For example, the change in the QP may result in a video sequence that has a different visual quality and/or SNR. SNR and bitrate may be related. For example, changing the QP during encoding may be a way to control bitrate. For example, if the QP is lower, then the encoded video sequence may have a higher SNR, a higher bitrate, and/or a higher visual quality.

The SNR of media content (e.g., an encoded video stream) may refer to the encoding of the media content. For example, the SNR of media content may be controlled by the QP used during encoding of the media content. For example, media content may be encoded at different rates to generate corresponding versions of the media content that may be characterized by different SNR values, for example, as described with reference to FIG. 2, FIG. 4, and FIG. 6. For example, the media content encoded at a high rate may be characterized by a high SNR value, while the media content encoded at a low rate may be characterized by a low SNR value. For example, the SNR of media content may refer to the encoding of the media content, and may not relate to the transmission channel over which the media content may be received by a client.

The frame resolution of one or more frames of media content (e.g., the horizontal and vertical dimensions of a video frame in pixels) may be controlled (e.g., between 240 p, 360 p, 720 p, 1080 p, etc.) during encoding to generated encoded versions of the media content with varying bitrates. For example, changing the frame resolution during encoding may change the bitrate of encoded versions of the media content (e.g., an encoded video sequence). Frame resolution and bitrate may be related. For example, if the frame resolution is lower, then a lower bitrate may be used to encode a video sequence at a similar visual quality.

The frame rate (e.g., the number of frames per second (fps)) of media content may be controlled (e.g., between 15 fps, 20 fps, 30 fps, 60 fps, etc.) during encoding to generated encoded versions of the media content with varying bitrates. For example, changing frame rate during encoding may change the bitrate of encoded versions of the media content (e.g., an encoded video sequence). Frame rate and bitrate may be related. For example, if the frame rate is lower, then a lower bitrate may be used to encode a video sequence at a similar subjective visual quality.

One or more of the parameters of media content (e.g., a video sequence) may be controlled (e.g., changed) during encoding to achieve a target bitrate of the media content for bandwidth adaptive streaming. The SNR (e.g., via the QP) of media content may be controlled during encoding to generate the media content encoded at different bitrates. For example, for one or more different bitrates, a video sequence may be encoded at the same frame rate (e.g., 30 frames per second) and the same resolution (e.g., 720 p), while the SNR of the encoded video sequence may be changed. Changing the SNR of the encoded video sequences may be useful when the range of target bitrates is relatively small (e.g., between 1 and 2 Mbps), for example, because changing the QP of the video sequenced may produce video sequences of good visual quality at the desired target bitrates.

The frame resolution of media content may be controlled to generate the media content encoded at different bitrates. The media content (e.g., a video sequence) may be encoded at the same frame rate (e.g., 30 frames per second) and the SNR, while the frame resolution of the frames of the media content may be changed. For example, video sequences may be encoded at one or more different resolutions (e.g., 240 p, 360 p, 720 p, 1080 p, etc.), while maintaining the same frame rate (e.g., 30 fps) and the same SNR. Changing the frame resolution of the media content may be useful when the range of the target bitrate is large (e.g., between 500 kbps and 10 Mbps).

The frame rate of media content may be controlled during encoding to generate the media content encoded at different bitrates. The media content (e.g., a video sequence) may be encoded at the same frame resolution (e.g., 720 p) and the same SNR, while the frame rate (e.g., 15 fps, 20 fps, 30 fps, 60 fps, etc.) of the media content may be changed. For example, video sequences may be encoded with lower frame rates to generate encoded video sequences of lower bitrates. For example, video sequences at higher bitrates may be encoded at full 30 fps, while video sequences at lower bitrates may be encoded at 5-20 fps, while maintaining the same resolution (e.g., 720 p) and the same SNR.

The SNR (e.g., via the QP) and frame resolution of media content may be controlled during encoding to generate the media content encoded at different rates. For example, video sequences may be encoded with lower SNR and frame resolution to generate encoded video sequences of lower bitrates, while the same frame rate may be used for the encoded video sequences. For example, video sequences at higher rates may be encoded at 720 p, 30 fps, and at a number of SNR points, while sequences at lower rates may be encoded at 360 p, 30 fps, and at the same SNR.

The SNR (e.g., via the QP) and frame rate of media content may be controlled during encoding to generate the media content encoded at different rates. For example, video sequences may be encoded with lower SNR and frame rates to generate encoded video sequences of lower bitrates, while the same frame resolution may be maintained for the encoded video sequences. For example, video sequences at higher rates may be encoded at 720 p, 30 fps, and at a number of SNR points, while video sequences at lower rates may be encoded at 720 p, 10 fps, and at the same SNR.

The frame resolution and frame rate of media content may be controlled during encoding to generate the media content encoded at different rates. For example, video sequences may be encoded with lower frame resolution and frame rate to generate encoded video sequences of lower bitrates, while maintaining the same visual quality (e.g., SNR) for the encoded video sequences. For example, video sequences at higher bitrates may be encoded at 720 p, at frame rates of 20 to 30 fps, and with the same SNR, while sequences at lower bitrates may be encoded at 360 p, at frame rates of 10 to 20 fps, and with the same SNR.

The SNR (e.g., via the QP), the frame resolution, and the frame rate of media content may be controlled during encoding to generate the media content encoded at different rates. For example, video sequences may be encoded with lower SNR, frame resolution, and frame rate to generate encoded video sequences of lower bitrates. For example, video sequences at higher bitrates may be encoded at 720 p, 30 fps, and at a higher SNR point, while video sequences at lower bitrates may be encoded at 360 p, 10 fps, and at a lower SNR point.

Implementations described herein may be used to smooth the transitions between media streams (e.g., video stream, audio stream, etc.) of media content (e.g., video, audio, etc.) that are characterized by a different bitrates, SNR, frame resolutions, and/or frame rates. Although described herein as a transition between media streams encoded at two different bitrates (e.g., high (H) and low (L)), SNR, frame resolutions, and/or frame rates, the implementations described herein may be applied to transitions between media streams encoded at any number of different bitrates, SNR, frame resolutions, and/or frame rates.

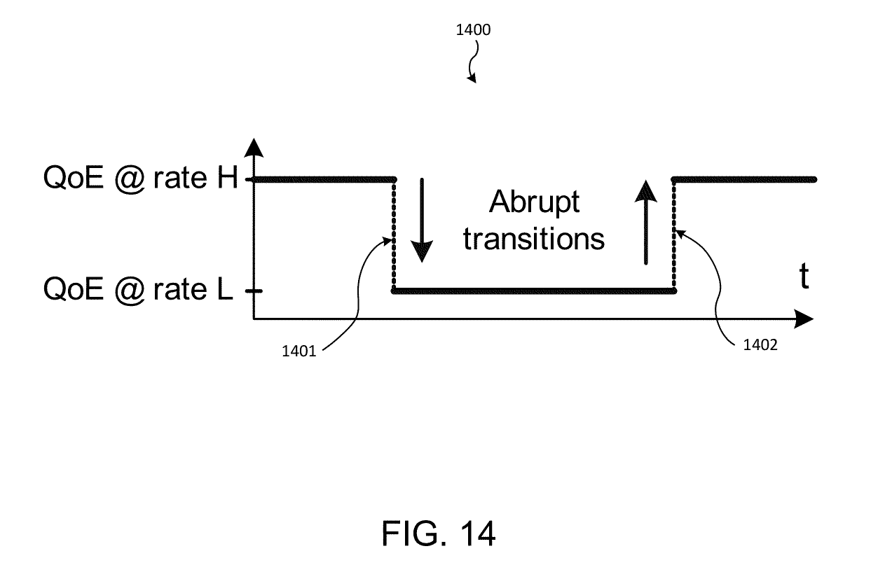

FIG. 14 is a graph 1400 illustrating an example of transitions between rates during a streaming session that do not include a smooth transition. Media content (e.g., video) may be encoded at a plurality (e.g., two) of different video rates, for example, a high rate (e.g., rate H) and a low rate (e.g., rate L), for example, as shown in FIG. 14. A transition may occur from a high rate (H) to a low rate (L) 1401 and/or from a low rate to a high rate 1402, for example as shown in FIG. 14. The transitions in a streaming session that does not include a smooth transition (e.g., 1401 and 1402 as illustrated in FIG. 14) may be referred to as abrupt transitions, for example, because the media content may transition from one rate to another (e.g., high to low, or low to high) without intervening portions (e.g., segments, frames, etc.) of the media content. The rate of the media content may refer to one or more parameter/characteristic of the media content, such as bitrate, SNR, resolution, and/or frame rate, for example.

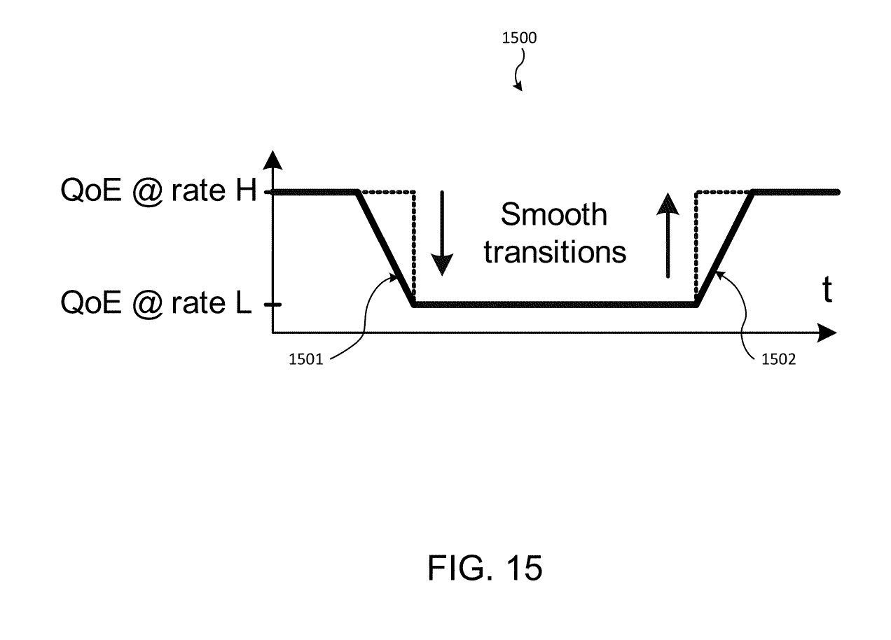

FIG. 15 is a graph 1500 illustrating an example of transitions between rates during a streaming session that do include smooth transitions. Smooth stream switching may utilize smooth transitions 1501, 1502 between rates (e.g., between rate H and rate L) that may be utilized to achieve a graceful step up/down of a visual quality of the media content. For example, a smooth transition 1501 may be utilized for a switch from rate H to rate L, while smooth transition 1502 may be utilized for a switch from rate L to rate H. Smooth transitions 1501, 1502 may provide for an improvement in the quality of experience (QoE). For example, a smooth transition may be achieved by using transition frames that are characterized by one or more parameters that are between the parameters of temporally corresponding frames encoded at the different rates (e.g., rate H and rate L).

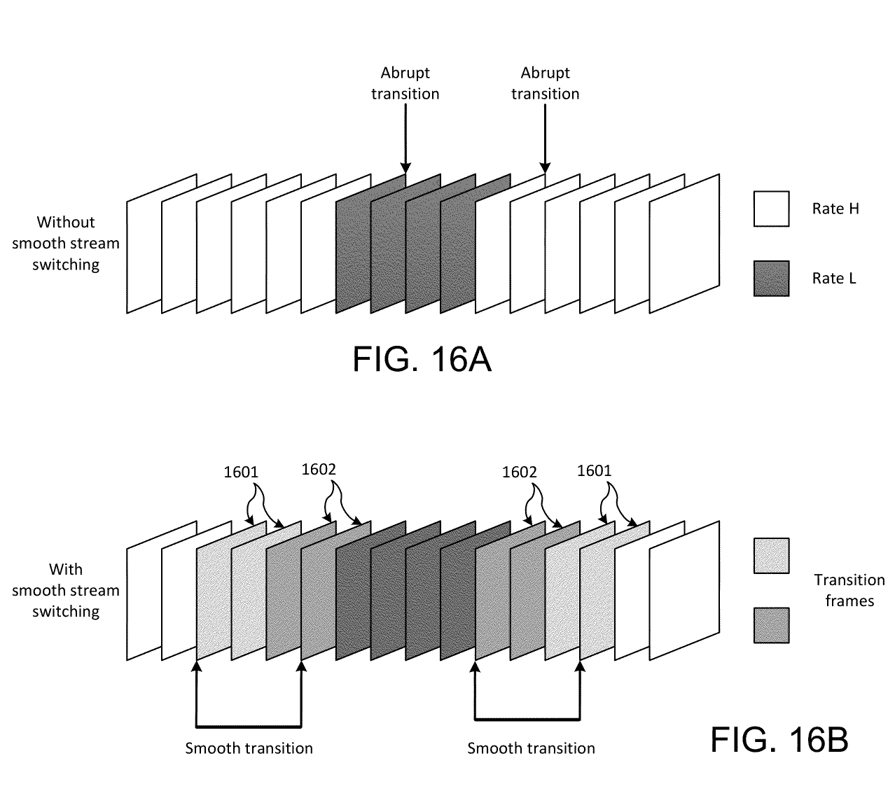

FIG. 16A is a diagram illustrating an example of transitions without smooth stream switching. FIG. 16B is a diagram illustrating an example of transitions with smooth stream switching. A smooth transition may include one or more intervening portions (e.g., segments, transition frames, etc.) of the media content between the media content encoded at the different rates. For example, as a result of using smooth stream switching, some of the frames at rate H (e.g., as shown in FIG. 16B) or rate L may be replaced by frames at decreasing (e.g., H-to-L transition) or increasing (e.g., L-to-H transition) visual quality. The frames utilized during a smooth transition may be referred to as transition frames.

If smooth stream switching is not utilized, for example as shown in FIG. 16A, then the transitions between rate H and rate L may be abrupt, for example, moving from a frame of one rate to a frame of the other rate without any transition frames. If smooth stream switching is utilized, for example as shown in FIG. 16B, then one or more transitions frames 1601, 1602 may be utilized between rates. Although four transition frames are utilized in each transition in the example illustrated in FIG. 16B, any number of transition frames may be utilized in a transition. Although transition frames of two different values 1601, 1602 are utilized in each transition in the example illustrated in FIG. 16B, any number of values of transition frames may be utilized in a transition. The values of transition frames in one transition (e.g., H to L transition) may be the same or different from the transition frames in another transition (e.g., L to H transition). Any number of values of transition frames may be utilized in a transition. The value of a transition frame may relate to one or more of the parameters (e.g., SNR, frame resolution, frame rate, etc.) that characterize the transition frame. For example, the transition frames 1601 may be defined by characteristics that are closer to the characteristics of the frames of rate H, while the transition frames 1602 may be defined by characteristics that are closer to the characteristics of the frames of rate L. The use of transition frames 1601, 1602 may provide for an improved QoE for the user.

Smooth stream switching may provide stream switches that may be less noticeable to a user, and which may improve the user experience. Smooth stream switching may allow for different segments of media content to utilize use different codecs, for example, by substantially eliminating differences in artifacts. Smooth stream switching may reduce the number of encodings/rates produced by a content provider for media content.

A streaming client may receive one or more streams of media content (e.g., video, audio, etc.) prepared by a DASH-compliant encoder. For example, the one or more streams of media content may include stream access points of any type, for example, types 1-6.

A client may include processing for concatenating and feeding encoded media segments to a playback engine. A client may include processing for decoding media segments, and/or applying cross-fade and/or post-processing operations. A client may load overlapping parts of media segments, and/or utilize the overlapping segments for smooth stream switching, for example, via the processing described herein.

Smooth stream switching between streams with different SNR (e.g., SNR points) may be performed using one or more of the implementations described herein, for example, using overlapping and crossfading, using transcoding and crossfading, using crossfading with scalable codecs, using progressive transcoding, and/or using post-processing. These implementations may be used for H-to-L and/or L-to-H transitions, for example.

Although described with reference to streams encoded at two different rates (e.g., H and L), the smooth stream switching implementations described herein may be utilized on streams of media content encoded at any number of different rates. The frame rate and/or resolution of the encoded streams of the media content (e.g., H and L) may be the same, while the SNR of the encoded streams of the media content may be different.

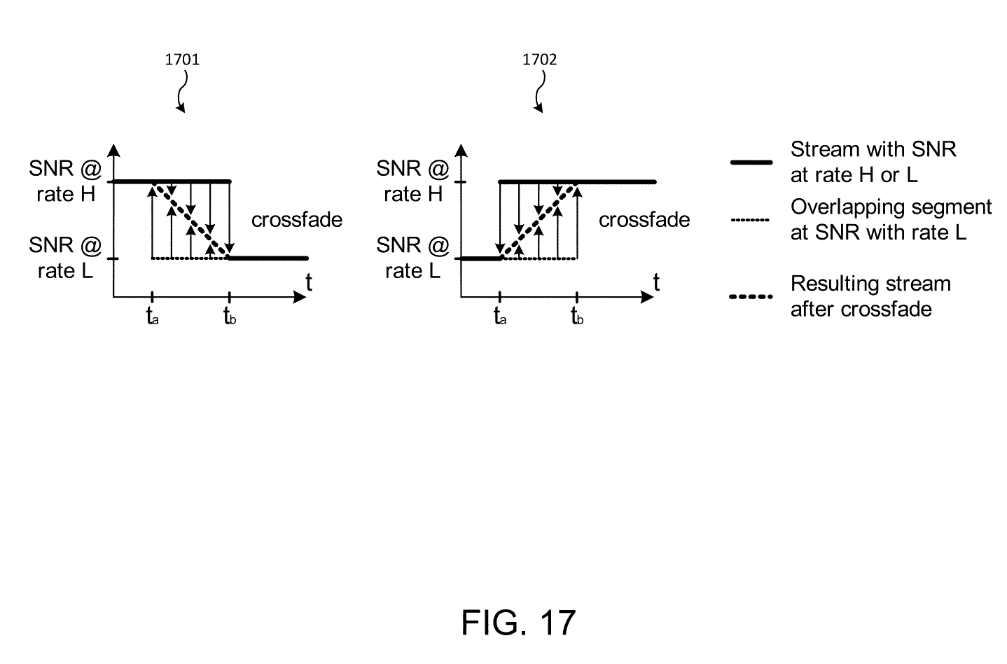

FIG. 17 is graphs illustrating examples of smooth stream switching transitions using overlapping and crossfading. A client may request and/or receive overlapping segments or sub-segments of media content and perform crossfade between encoded streams of the media content, for example, using the overlapping segments or sub-segments. The overlapping request may be a request of one or more segments of media content encoded at one or more different rates. The overlapping segments may be characterized by temporally corresponding segments of the media content encoded at two or more different rates (e.g., and different SNR). Segments encoded at two or more different rates may be received, for example, for at least the duration of the transition time. For example, as shown in FIG. 17, overlapping segments encoded at rate H and at rate L may be received for the time interval of tₐ to t_{b}. The time interval associated with the overlapping request may be referred to an overlap time interval (e.g., tₐ to t_{b} in FIG. 17). The graph 1701 illustrates a transition from rate H to rate L, while the graph 1702 illustrates a transition from rate L to rate H.

A client may request and/or receive overlapping segments or sub-segments of media content and perform crossfade between encoded streams of the media content, for example, using the overlapping segments or sub-segments. Sub-segments of a particular segment may be utilized for smooth stream switching. For example, if a segment is of a longer duration, such as more than 30 seconds, for example, then the client may request and/or receive overlapping sub-segments of that segment, such as 2-5 seconds worth of sub-segments, for example, to perform smooth stream switching. Segment(s) may refer to the entire segment(s) and/or may refer to one or more sub-segments of the segment(s).

After receiving overlapping segments, crossfading may be performed between the frames of the overlapping segments to generate one or more transition frames. For example, crossfading may be performed between the frames encoded at rate H and the temporally corresponding (e.g., overlapping) frames encoded at rate L, as shown in FIG. 17. For example, crossfading may be performed over a portion or the entire overlap time interval of tₐ to t_{b}. Transition frames may be generated in the overlap time interval (e.g., the time tₐ to t_{b} of FIG. 17) via crossfading the overlapping segments. The transition frames may be characterized by a transition time interval. The transition time interval may relate to a time period in which the client may transition from the media content encoded at one rate to the media content encoded at another rate. The number of transition frames may or may not equal the number of overlapping frames. Therefore, the transition time interval may or may not equal the overlap time interval.

Crossfading may include calculating a weighted average of the overlapping frames encoded at one rate with the overlapping frames encoded at another rate such that the resulting transition frames have parameters that gradually transition from one rate to another over the transition time interval. For example, the weights applied to the overlapping frames encoded at each rate may change over time (e.g., the transition time interval) such that the generated transition frames may be utilized for a more gradual transition between the media content encoded at the various rates. For example, crossfading may include calculating a weighted average of one or more frames characterized by one rate (e.g., a first SNR) and one or more frames characterized by another rate (e.g., a second SNR), for example, by applying a first weight to the frames characterized by the first rate and a second weight to the frames characterized by the second rate. At least one of the first weight and the second weight may change over time (e.g., the transition time interval). For example, crossfading may refer to a smooth fade-in or alpha-blending.

After generating the transition frames via crossfading, the transition frames may be displayed by the client, for example, instead of the temporally corresponding frames at one or more of the rates (e.g., rate H and/or rate L). For example, the client may display one or more frames of the media content encoded at one rate (e.g., rate H) before the transition and/or overlap time interval, display one or more transition frames during the transition and/or overlap time interval, and display one or more frames of the media content encoded at another rate (e.g., rate L) after the transition and/or overlap time interval, for example, in that order. This may provide a smooth transition between the media content encoded at different rates.

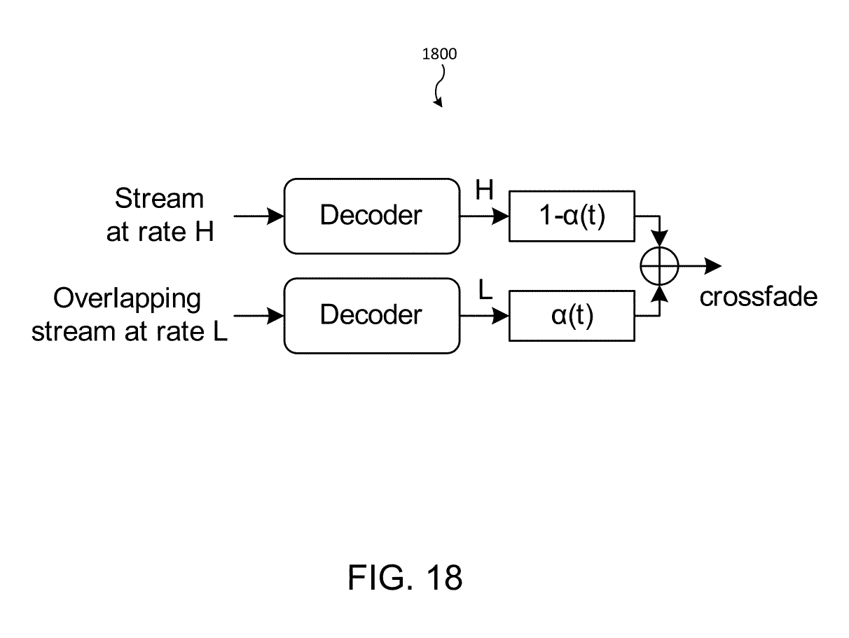

FIG. 18 is a diagram illustrating an example of a system 1800 for overlapping and crossfading streams. The system 1800 shown in FIG. 18 may be utilized for a H-to-L transition. The system 1800 shown in FIG. 18 may perform a crossfading of the overlapping segments of the media content according to the following equation:

z=α(t)L+[1−α(t)]H, where αa(t)=(t−tₐ)/(t_{b}−tₐ) for tₐ<t<t_{b}.

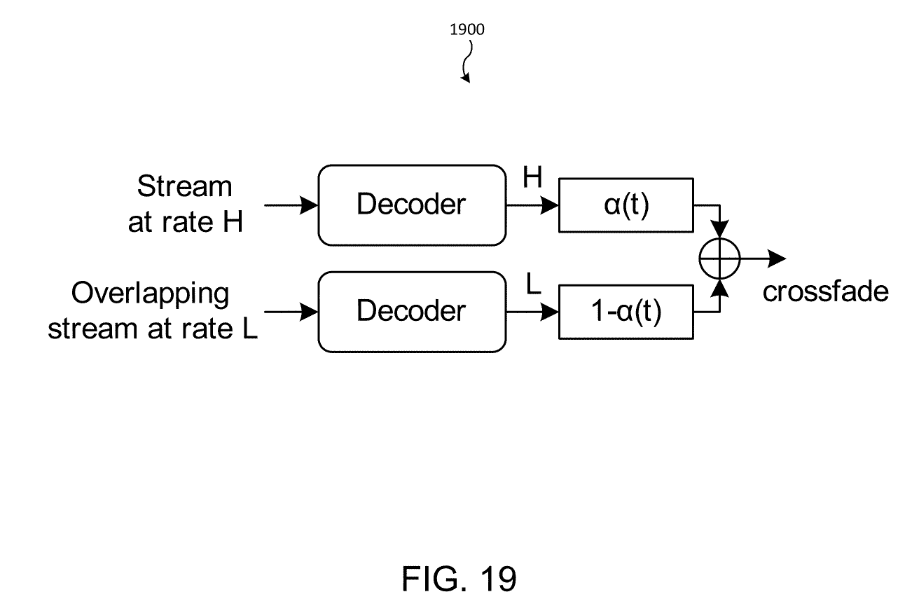

FIG. 19 is a diagram illustrating an example of a system 1900 for over lapping and crossfading streams. The system 1900 shown in FIG. 19 may be utilized for a L-to-H transition. The system 1900 shown in FIG. 19 may perform a crossfading of the overlapping segments of the media content according to the following equation:

z=α(t)H+[1−α(t)]L, where α(t)=(t−tₐ)/(t_{b}−tₐ) for tₐ<t<t_{b}.

Equations described with reference to the systems of FIG. 18 and FIG. 19 may be utilized to perform crossfading using a linear transition between the frames of media content encoded at the different rates (e.g., the H frames and the L frames). A linear transition may be characterized by α(t) varying (e.g., linearly or non-linearly) through the transition time, for example, between 0 and 1.

The overlapping stream at a rate (e.g., rate L) may be partitioned into sub-segments, for example, when utilizing overlapping and crossfading transitions in DASH. For example, if the overlapping stream at rate L is partitioned in sub-segments, then time tₐ (e.g., for a H-to-L transition) or time t_{b} (e.g., for a L-to-H transition) may be selected such that they match the beginning or end, respectively, of a sub-segment, for example, as shown in FIG. 17. If the overlapping stream at rate L is not partitioned in sub-segments, then a complete segment may be obtained in the overlapping request, and then decoded. Time tₐ (e.g., for a H-to-L transition) or time t_{b} (e.g., for a L-to-H transition) may be selected such that enough frames are available to perform a smooth transition.

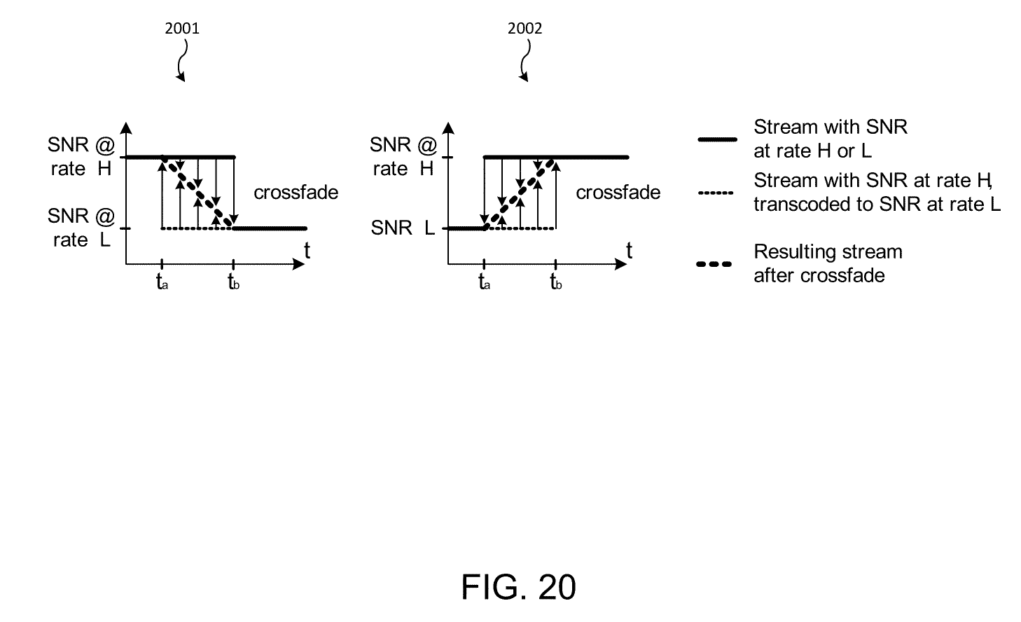

FIG. 20 is graphs illustrating examples of smooth stream switching using transcoding and crossfading. The media content at the high (H) SNR may be transcoded to the rate or level of the low (L) SNR, for example, to generate temporally corresponding media content at both the high SNR and the low SNR (e.g., for the time between tₐ and t_{b} as shown in FIG. 20). For example, transcoding may be performed to generate one or more temporary corresponding segments of media content characterized by rate L using one or more segments characterized by rate H.

After transcoding, the temporally corresponding media content at rate H (e.g., a high SNR) and rate L (e.g., a low SNR) may be utilized similarly as the overlapping segments described herein. For example, the temporally corresponding media content at rate H (e.g., the high SNR) and at rate L (e.g., the low SNR) may be crossfaded to generate one or more transition segments. The transition frames may be displayed instead of the temporally corresponding frames at rate H (e.g., the SNR H), for example, during the transition time (e.g., the time between tₐ and t_{b} in FIG. 20). The graph 2001 illustrates a transition from rate H to rate L, while the graph 2002 illustrates a transition from rate L to rate H. A smooth transition from H-to-L SNR levels and/or from L-to-H SNR levels may be achieved by using a transcoding and crossfading, for example, as shown in FIG. 20.

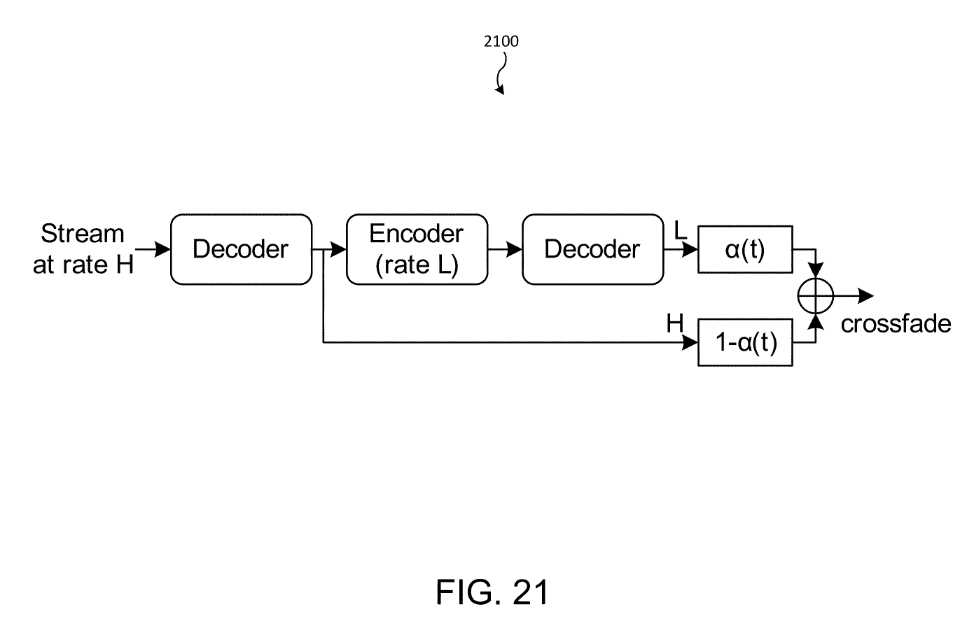

FIG. 21 is a diagram illustrating an example of a system 2100 for transcoding and crossfading. The system 2100 shown in FIG. 21 may be utilized for a H-to-L transition. The system 2100 shown in FIG. 21 may perform a crossfading of the media at the high SNR and the transcoded media at the low SNR according to the following equation:

z=α(t)L+[1−α(t)]H, where α(t)=(t−tₐ)/(t_{b}−tₐ) for tₐ<t<t_{b}.

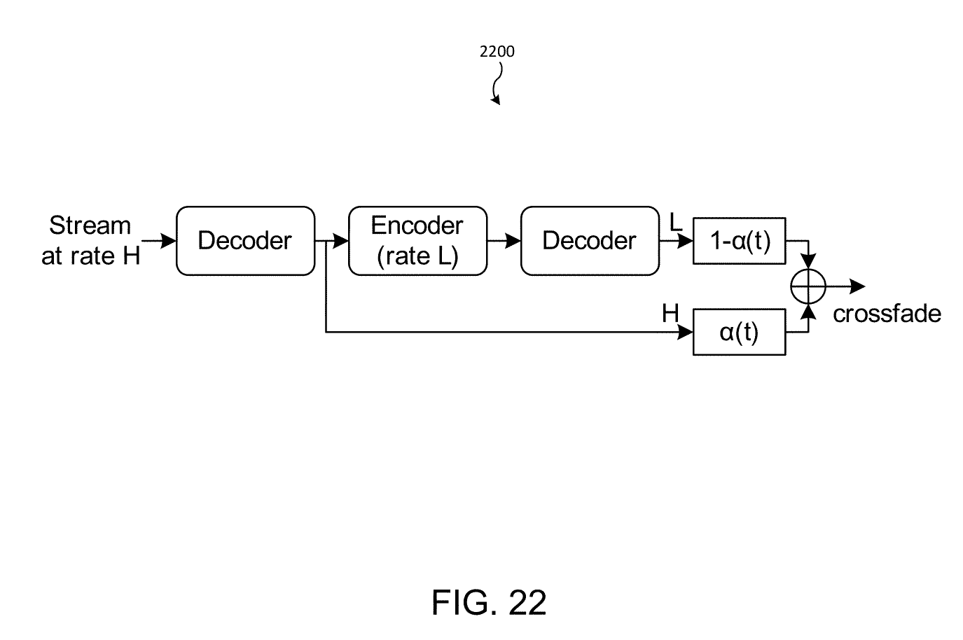

FIG. 22 is a diagram illustrating an example of a system 2200 for transcoding and crossfading. The system 2200 shown in FIG. 22 may be utilized for a L-to-H transition. The system 2200 shown in FIG. 22 may perform a crossfading of the media at the high SNR and the transcoded media at the low SNR according to the following equation:

z=α(t)H+[1−α(t)]L, where α(t)=(t−tₐ)/(t_{b}−tₐ) for tₐ<t<t_{b}.

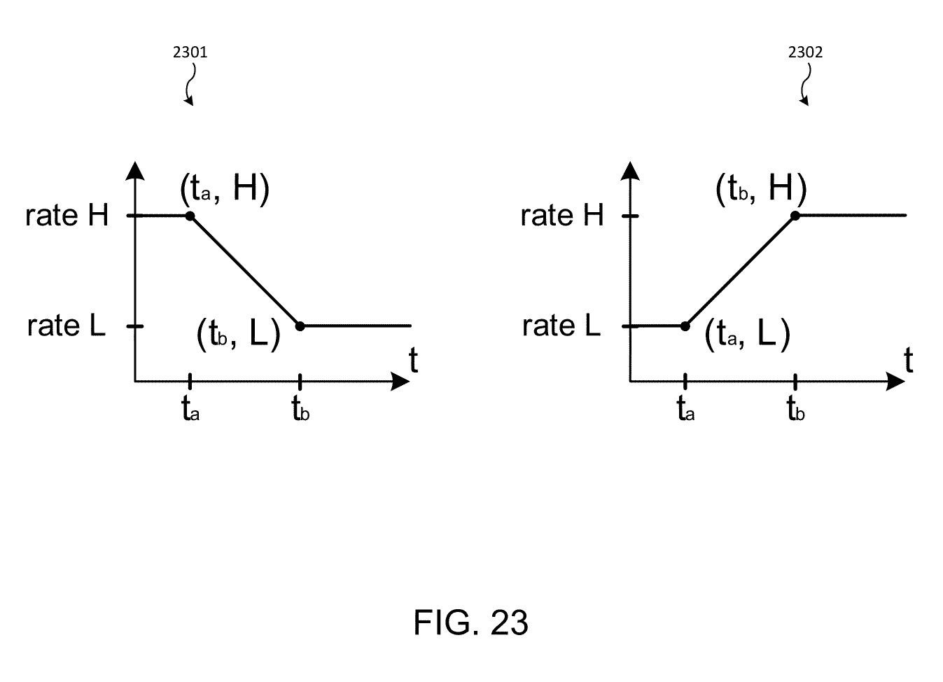

FIG. 23 is graphs illustrating examples of crossfading using a linear transition between rates H and L. The graph 2301 illustrates a linear transition from rate H to rate L, while the graph 2302 illustrates a linear transition from rate L to rate H. FIG. 23 illustrates an example of a line passing over two points according to the following equation:

y−y1=m(x−x1), where m=(y2−y1)/(x2−x1).

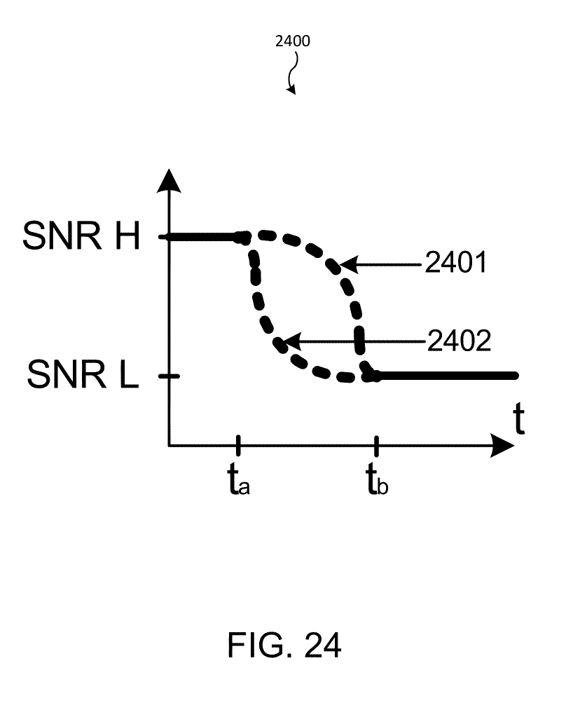

Other types of crossfading besides a linear transition, for example, non-linear transitions, may be used. For example, α(t) may vary non-linearly. FIG. 24 is a graph 2400 illustrating examples of non-linear crossfading functions. For example, FIG. 24 illustrates an example of a non-linear crossfading function that is slower 2401 and one that is faster 2402 from H-to-L as compared with the linear crossfading function from H-to-L.

For example, for a non-linear transition, α(t) may be a non-linear function, a logarithmic function, and/or an exponential function. For example, a non-linear function may be a polynomial of degree two or higher (e.g., α(t) may be a polynomial of degree two, where α(t)=a*t²+b*t+c). For example, a logarithmic function may be defined as: α(t)=log(α(t)), where log may be a logarithm base “b” and α(t) may be a function of t. For example, an exponential function may be defined as: α(t)=exp(α(t)), where exp may be the base (e.g., “2,” “e,” “10,” etc.) and α(t) may be a function of t. α(t) may be a linear function, a non-linear function, a logarithmic function, or exponential function of t.

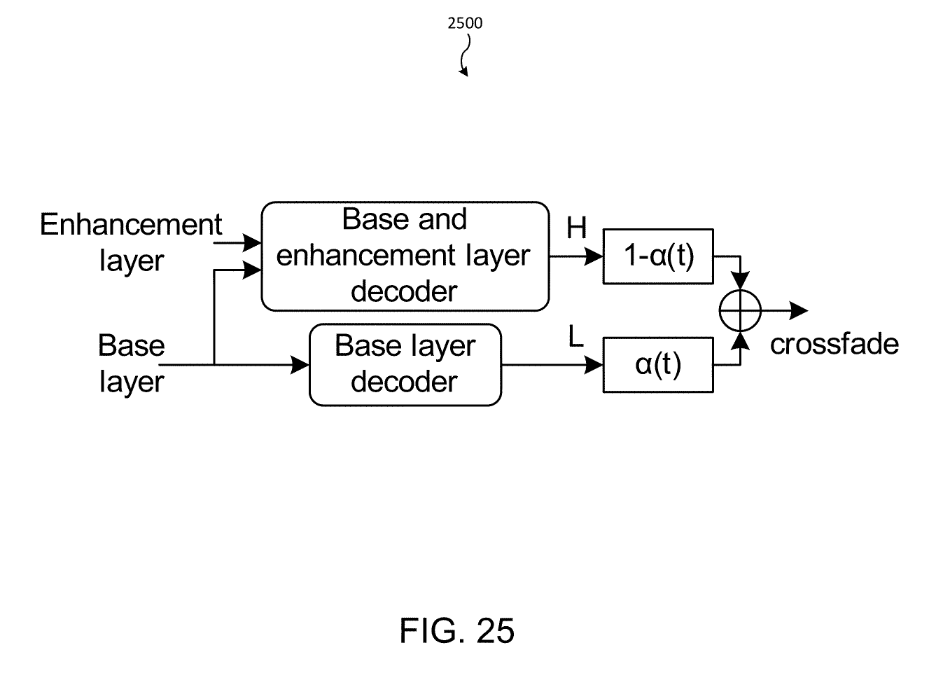

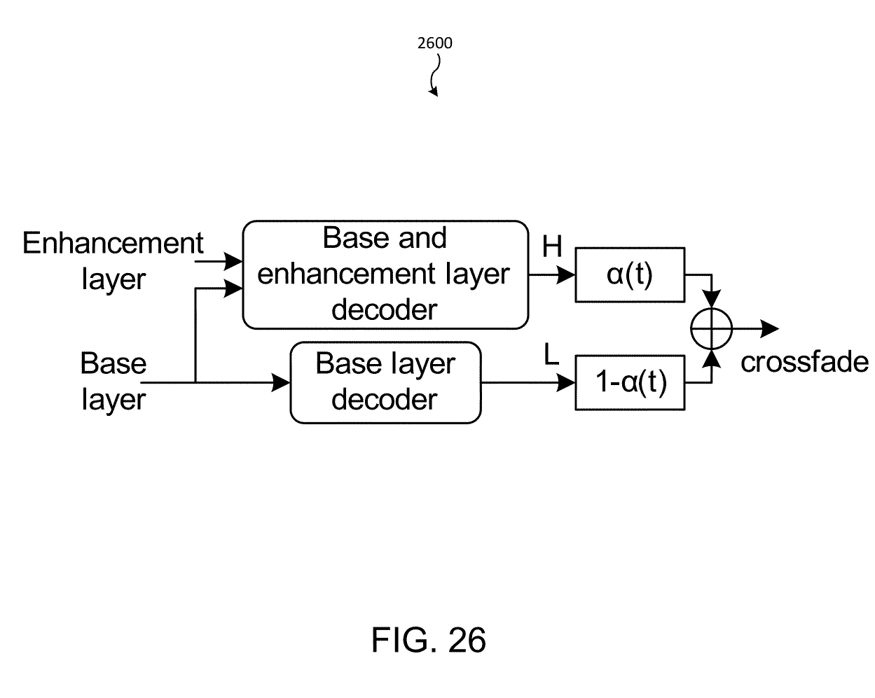

FIG. 25 is a diagram illustrating an example of a system 2500 for crossfading scalable video bitstreams. FIG. 26 is a diagram illustrating an example of a system 2600 for crossfading scalable video bitstreams. When a scalable video codec is used, then smooth switching between different layers may be performed using crossfading between the base layer and the enhancement layer, for example, as described herein with respect to overlapping segments. FIG. 25 and FIG. 26 illustrate example systems 2500, 2600 for smooth stream switching for a scalable video codec for the H-to-L and L-to-H transitions respectively. There may be one base layer and one or more enhancement layers for a scalable video bitstream. An enhancement layer may improve a previous layer (e.g., base layer or lower enhancement layer). For example, an enhancement layer may improve the SNR, the frame rate, and/or the resolution of the previous layer. For example, the L representation may be obtained by decoding the base layer, while the H representation may be obtained by decoding the base layer and one or more enhancement layers.

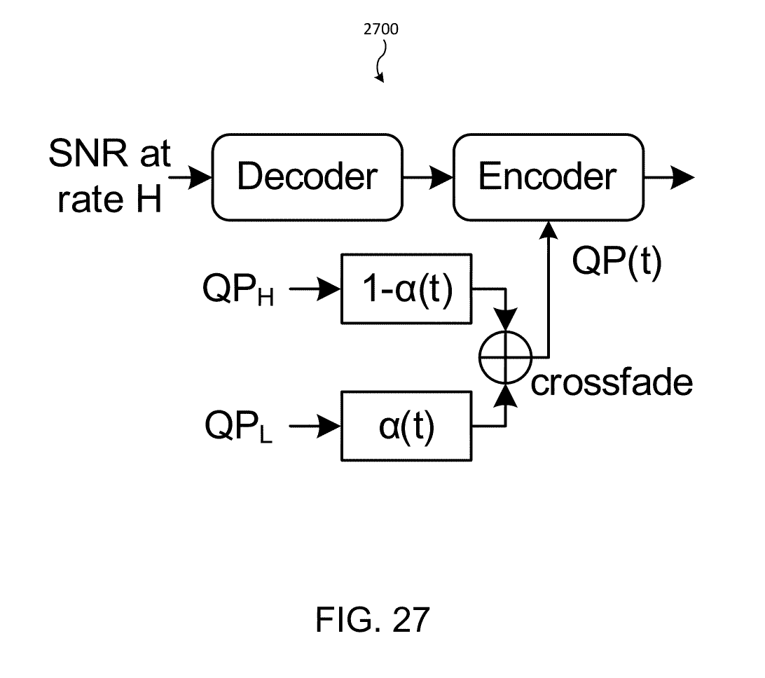

FIG. 27 is a diagram illustrating an example of a system 2700 for progressive transcoding using QP crossfading. Smooth switching may be performed by transcoding media content (e.g., a video stream) with a SNR at rate H and controlling the QP using crossfading between QPH and QPL, for example, as shown in FIG. 27. Although not illustrated in FIG. 27, a decoder may be provided after the encoder, whereby the output of this decoder may be one or more transition frames that may be utilized for smooth stream switching. The QP of the H representation and the L representation may be obtained. For example, the QP may be signaled in the bitstream, signaled in the MPD, and/or may be estimated by a decoder. Crossfading may be performed between the QP of the H representation and the L representation. The resulting QP value may be used to re-encode the sequence to generate one or more transition frames. For example, the one or more transition frames may be generated in a manner similar to as described with reference to FIG. 21 and FIG. 22, for example, example that rather than performing crossfading on the decoded frames (as in FIG. 21-22), crossfading may be performed in the QP domain to generate a bitstream that may have a varying SNR.

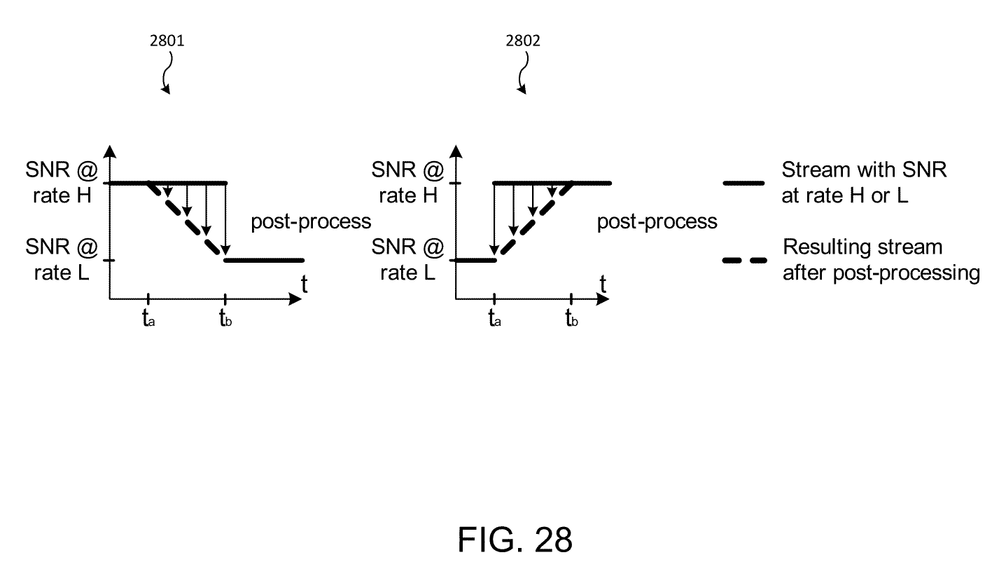

FIG. 28 is a diagram illustrating examples of smooth stream switching using post-processing. Smooth stream switching using post-processing may refer to the use of post-processing techniques, such as filtering and re-quantization, for example, to generate one or more transition frames to be used for switching between streams having different parameters (e.g., SNR, resolution, bitrate, etc.). The post-processing may be performed on the media content characterized by one or more higher parameter(s) (e.g., a higher SNR as shown in FIG. 28). For example, a stream at rate H may be post-processed to effect a gradual transition to or from a stream at rate L. Post-processing may be utilized to generate transition frames that may otherwise be generated or obtained via overlapping and crossfading and/or transcoding and crossfading. The transition frames generated via post-processing may be displayed during the transition time (e.g., the time between tₐ and t_{b}) instead of the temporally corresponding frames at rate H, for example, as shown in FIG. 28. The graph 2801 illustrates a transition from rate H to rate L, while the graph 2802 illustrates a transition from rate L to rate H. Post-processing may reduce the computational burden at the client. Post-processing may not increase network traffic, as overlapping requests may not be utilized.

The input for post-processing may be media content encoded at a higher rate and/or characterized by higher parameter(s) (e.g., frames encoded with a higher SNR). The output of post-processing may be transition frames that may be utilized during the transition time to more gradually transition from a stream encoded at one rate to a stream encoded at another. Various post-processing techniques, such as filtering and re-quantization, for example, may be used to degrade visual quality of media content to generate transition frames.

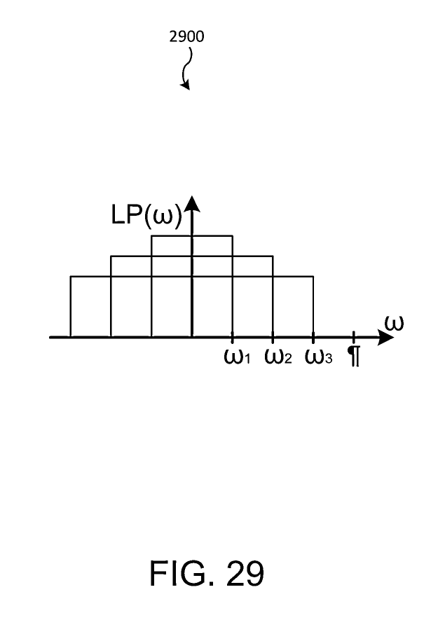

Filtering may be utilized as a post-processing technique to generate transition frames for smooth stream switching. FIG. 29 is a graph 2900 illustrating an example of frequency response of low-pass filters with different cutoff frequencies. A low-pass filter of varying strength (e.g., or a one or more low-pass filters of non-varying strength) may be applied to media content encoded at a higher rate and/or characterized by higher parameters (e.g., frames encoded with a higher SNR), for example, to generate one or more transition frames. Low-pass filtering may simulate the effect of a higher compression that may be used to generate transition frames at rates lower than H.

The strength (e.g., the cutoff frequency) of the low-pass filter may vary according to the desired degree of degradation of the frame at rate H, for example, as shown in FIG. 29. For example, if h(m,n) is the frame at rate H and lp(k,l) is a finite impulse response (FIR) low-pass filter, then the post-processed frame p(m,n) (e.g., transition frame) may be generated according to the following equation:

p(m,n)=h(m,n)*lp(k,l), where “*” may denote convolution.

Re-quantization may be utilized as a post-processing technique to generate one or more transition frames for smooth stream switching. For example, the pixel values of a frame at rate H may be transformed and quantized at different levels to generate transition frames at rates lower than H. One or more quantizers (e.g., uniform quantizers) may be utilized to generate transition frames. For example, the one or more quantizers may be characterized by step sizes that vary according to the desired degree of degradation of a frame at rate H. A larger step size may result in greater/higher degradation, and/or be utilized to generate a transition frame that more closely resembles a frame at rate L. The number of quantization levels may be sufficient to avoid contouring (e.g., contiguous regions of pixels with constant levels, whose boundaries may be referred to as contours). If h(m,n) is the frame at rate H, and Q(•, s) is a uniform quantizer of step size s, then the post-processed frame p(m,n) (e.g., transition frame) may be generated using pixel quantization according to the following equation:

p(m,n)=Q(h(m,n),s).

Smooth switching may be utilized with streams having different spatial resolutions. A client device (e.g., a smartphone, tablet, etc.) may stretch a video to full screen during streaming playback. Stretching a video to full screen may enable a switch between streams encoded at different spatial resolutions during the streaming session. Up-sampling streams from low resolutions may cause visual artifacts, which may cause the video to become blurred, for example, because high frequency information may be lost during down-sampling.

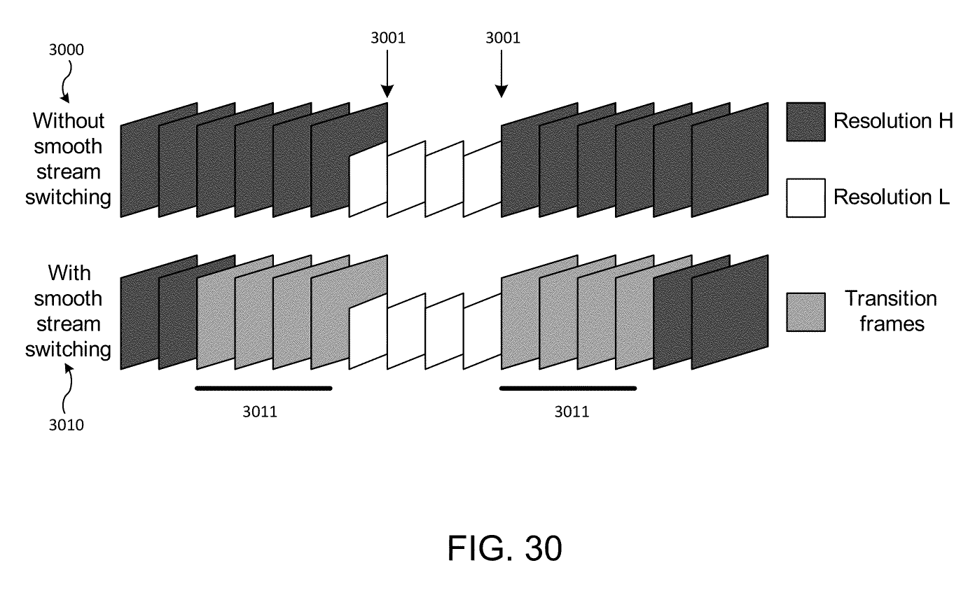

FIG. 30 is a diagram illustrating an example of smooth switching for streams with different frame resolutions. Diagram 3000 is an example that does not utilize smooth stream switching and includes abrupt transitions 3001. Diagram 3010 is an example that does utilize smooth stream switching and include smooth transitions 3011. For performing smooth switching between streams with different frame resolutions, the visual artifacts that may occur due to upsampling of low resolution frames may be minimized, for example, as shown in FIG. 30. The frame rate and/or frame exposure times in streams H and L may be the same.

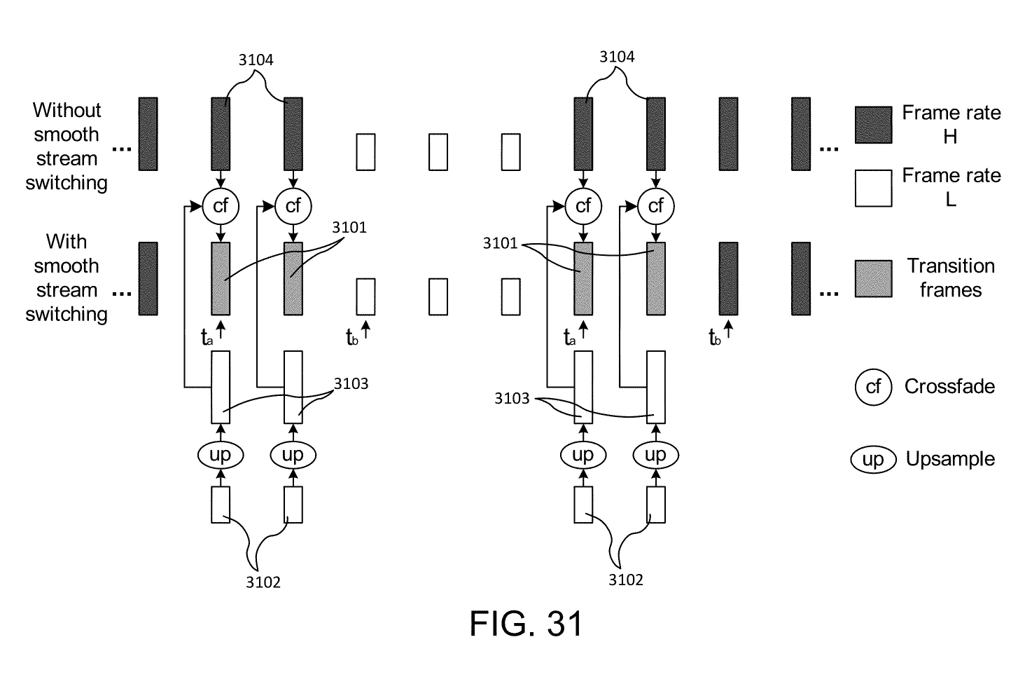

FIG. 31 is a diagram illustrating an example of generating one or more transition frames for streams with different frame resolutions. One or more transition frames 3101 may be generated using information from the media content encoded at different rates (e.g., a video stream at frame rate H and/or at frame rate L), for example, as shown in FIG. 31. An overlapping segment of the media content 3102 at one frame resolution (e.g., frame resolution L) over a transition time (e.g., from tₐ and t_{b}) may be requested and/or received by the client. Over the transition time (e.g., between ta and tb), one or more frames 3102 at the same temporal position from the media content encoded at the lower rate may be upsampled to the same resolution as the media content encoded at the higher resolution to generate one or more upsampled frames 3103. For example, one or more frames 3102 of stream L may be upsampled to the same resolution as the frames from stream H. Upsampling may be performed using built-in functionality of the client. An upsampled frame 3103 at the same temporal position as the frames from streams H 3104 and L 3102 may be utilized to generate a temporally corresponding transition frame 3101, for example, by using crossfading. The transition frame 3101 may then be utilized during playback during smooth switching from one resolution to another (e.g., H-to-L or L-to-H).

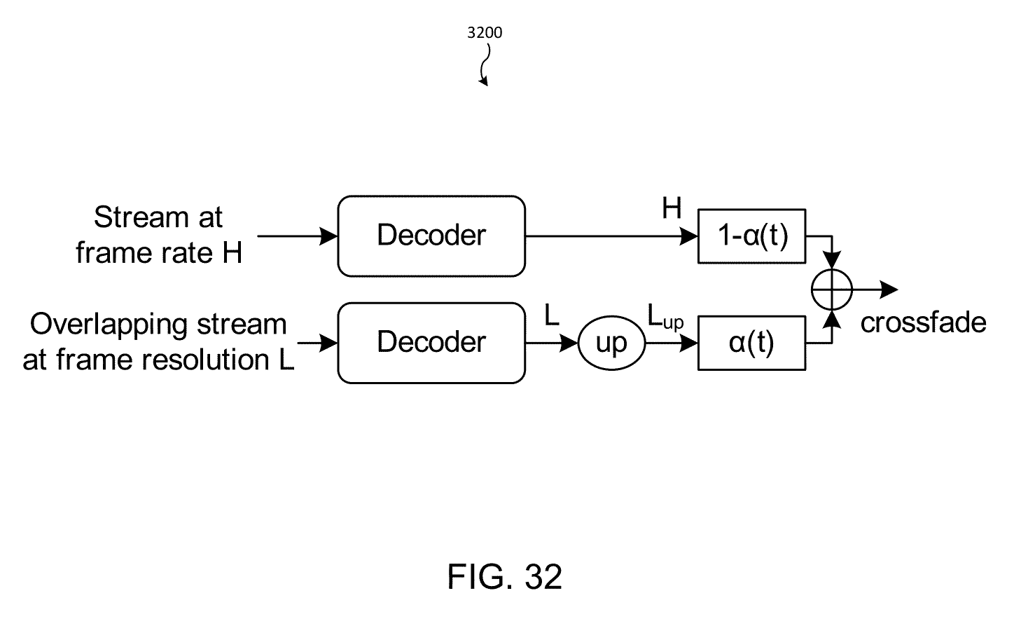

FIG. 32 is a diagram illustrating an example of a system 3200 for crossfading on a H-L transition for streams with different frame resolutions. The system 3200 of FIG. 32 may perform crossfading over the H-to-L transition according to the following equation:

z=α(t)L+[1−α(t)]H, where α(t)=(t−tₐ)/(t_{b}−tₐ) for tₐ<t<t_{b}.

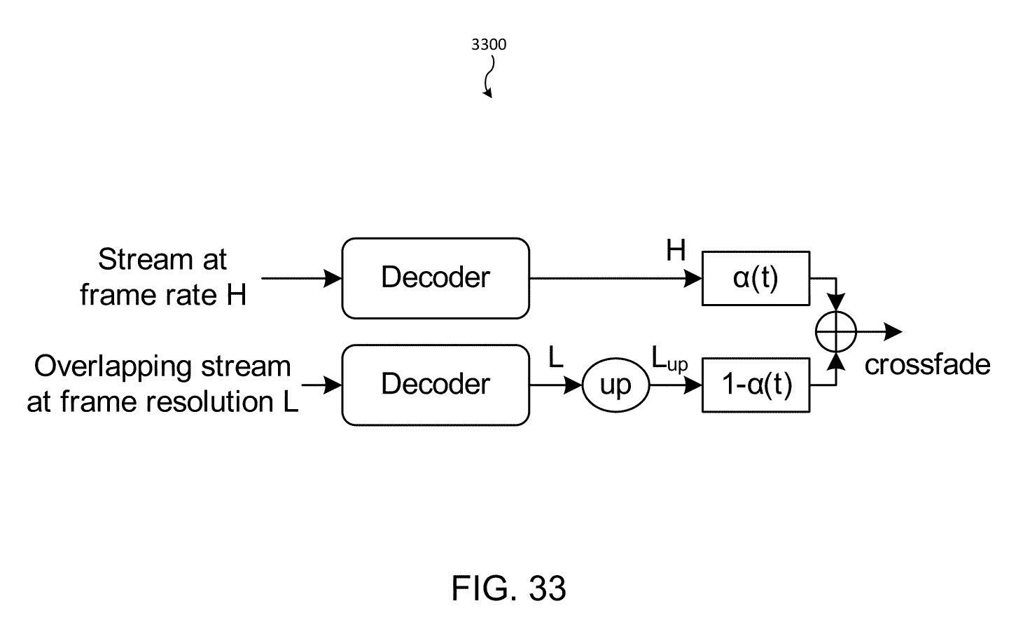

FIG. 33 is a diagram illustrating an example of a system 3300 for crossfading on L-H transition for streams with different frame resolutions. The system 3300 of FIG. 33 may perform crossfading over the L-to-H transition according to the following equation:

z=α(t)H+[1−α(t)]L, where α(t)=(t−tₐ)/(t_{b}−tₐ) for tₐ<t<t_{b}.

Smooth stream switching may be utilized with streams having different frame rates. Media content (e.g., video streams) with a low frame rate may suffer from poor temporal correlation between frames, for example, because frames may be farther apart in time from each other as compared to media content with higher frame rate. Frame rate upsampling (FRU) techniques may be utilized to convert a stream of media content with a low frame rate to a high frame rate.

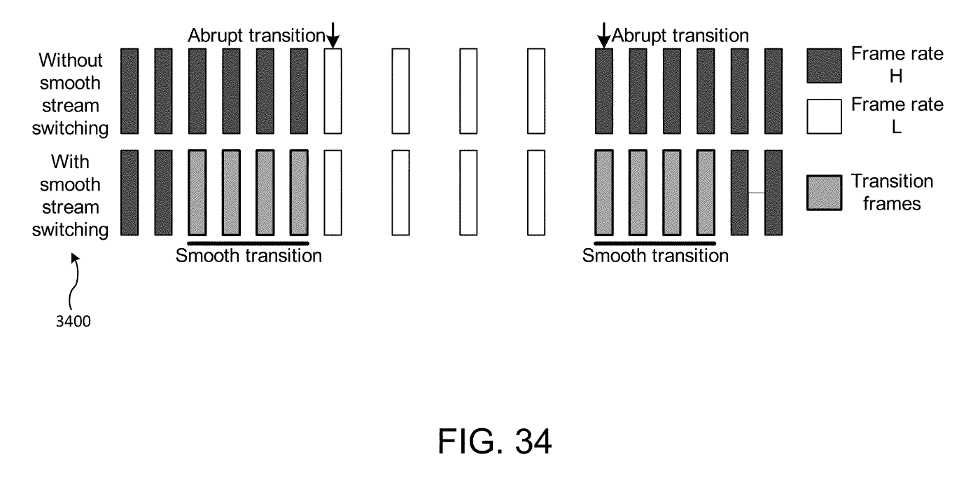

FIG. 34 is a diagram illustrating an example of a system 3400 for smooth switching for streams with different frame rates. Smooth switching between streams with different frame rates may be utilized to minimize the visual artifacts due to low frame rates, for example, as shown in FIG. 34. The frame resolution of the H frame rate stream and the L frame rate stream may be the same.

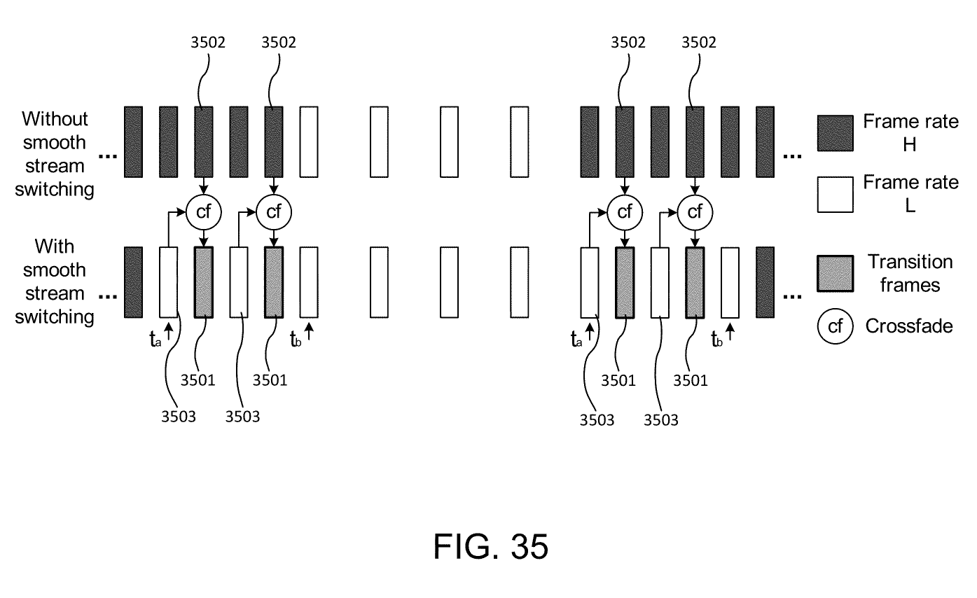

FIG. 35 is a diagram illustrating an example of generating one or more transition frames for streams with different frame rates. One or more transition frames 3501 may be generated using information from a stream of the media content encoded at a high frame rate (e.g., frame rate H) and a stream of the media content encoded at a low frame rate (e.g., frame rate L), for example, as shown in FIG. 35. The client may request and/or receive an overlapping segment of the media content at the lower frame rate (e.g., frame rate L) over a transition time (e.g., between tₐ and t_{b}). The overlapping frame may be requested and/or received in addition to a corresponding temporal frame encoded at a high rate. Over the transition time (e.g., between tₐ and t_{b}), one or more transition frames 3501 may be generated. For example, a transition frame 3501 may be generated using a frame encoded at frame rate H 3502 and a temporally preceding frame encoded at frame rate L 3503, for example, by crossing the frames. The generated transition frame 3501 may be utilized in the same temporal position as the frame encoded at frame rate H 3502, but not the same temporal position as the frame encoded at frame rate L 3503. There may not be a frame encoded at frame rate L in the same temporal position as the generated transition frame 3501, for example, as shown in FIG. 35.

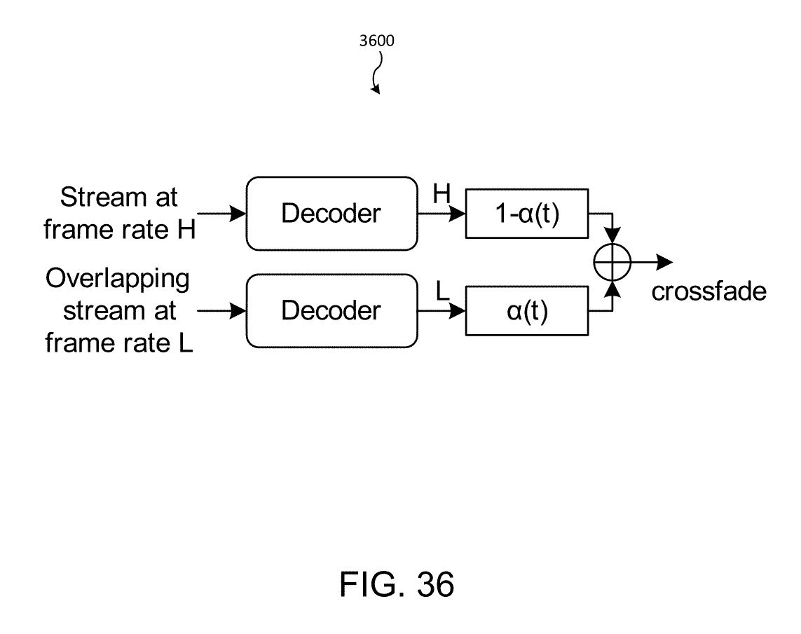

FIG. 36 is a diagram illustrating an example of a system 3600 for crossfading on H-L transition for streams with different frame rates. The system 3600 of FIG. 36 may perform crossfading over the H-to-L transition according to the following equation:

z=α(t)L+[1−α(t)]H, where α(t)=(t−tₐ)/(t_{b}−tₐ) for tₐ<t<t_{b}.

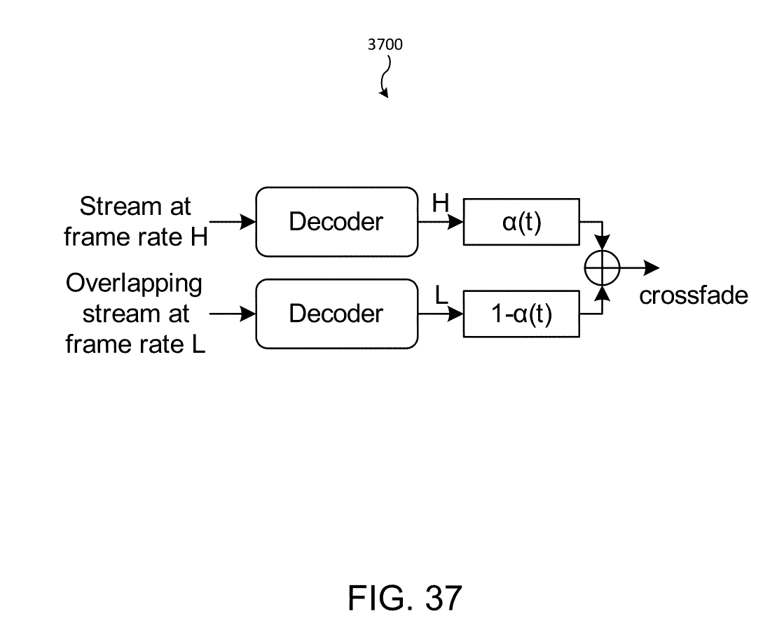

FIG. 37 is a diagram illustrating an example of a system 3700 for crossfading on L-H transition for streams with different frame rates. The system 3700 of FIG. 37 may perform crossfading over the L-to-H transition according to the following equation:

z=α(t)H+[1−α(t)]L, where α(t)=(t−tₐ)/(t_{b}−tₐ) for tₐ<t<t_{b}.

Asymmetry of duration for smoothening H-to-L and/or L-to-H transitions may be utilized. A transition from a low-quality representation to a high-quality representation may be characterized by a less degrading effect than a transition from a high-quality representation to a low-quality representation. The time delays for smoothening transitions from H-to-L and from L-to-H may be different. For example, longer transitions (e.g., transition including more transition frames) may be longer for H-to-L transition and shorter for L-to-H transitions. For example, a transition of a couple seconds (e.g., two seconds) may be utilized for H-to-L quality transitions, and/or a slightly shorter transition (e.g., one second) may be utilized for L-to-H transitions.

Smooth stream switching may be utilized for audio transitions, for example, in DASH. The DASH standard may define one or more types of connections between streams, which may be referred to as SAPs. A SAP may be utilized to ensure that catenation of streams along these points may produce a correctly decodable MPEG stream.

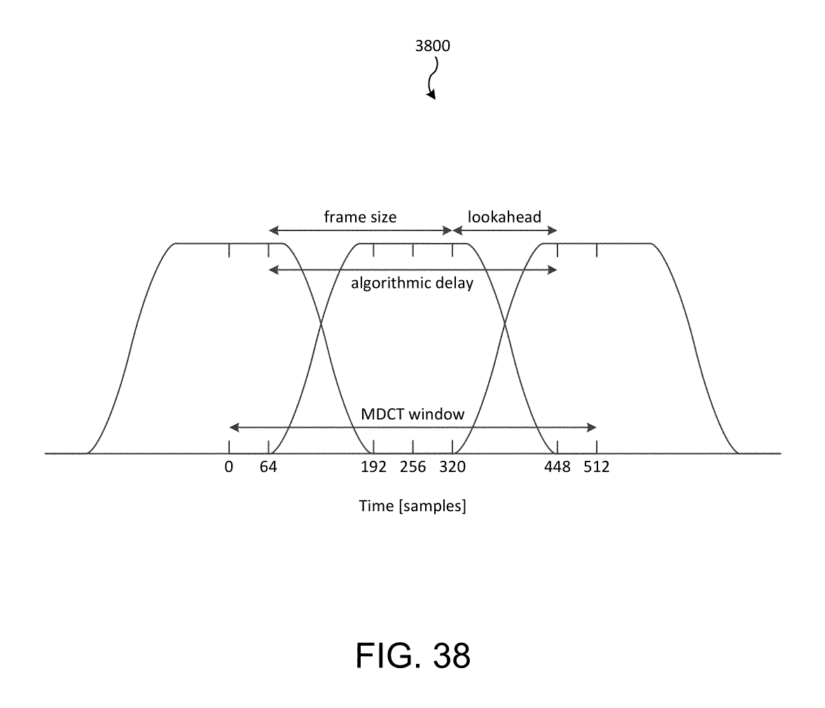

FIG. 38 is a graph 3800 illustrating an example of overlap-add windows used in MDCT-based speech and audio codecs. Audio streams may not include an I-frame (e.g., or an equivalent of an I-frame). Audio codecs, such as MP3, MPEG-4 AAC, HE-AAC, etc., for example, may encode audio samples in units called blocks (e.g., 1024 and 960 sample blocks). The blocks may be inter-dependent. The nature of this interdependence may rely in overlapping windows which may be applied to samples in these blocks prior to computing transform (e.g., MDCT), for example, as shown in FIG. 38.

An audio codec may decode and discard one block at the beginning. This may be sufficient mathematically for correct decoding of all blocks that follow, for example, due to a perfect-reconstruction property of the MDCT transform that may employ overlapping windows. A block proceeding the block that is being decoded may be retrieved, decoded, and then discarded prior to decoding the requested data, for example, in order to achieve random access. For an audio codec (e.g., HE-AAC, AAC-ELD, MPEG-Surround, etc.), the number of blocks to be discard at the beginning may be more or less than one (e.g., three blocks), for example, due to the use of an SBR tool.

Audio segments may be unlabeled (e.g., do not include a StartWithSAP attribute), or labeled with SAP type=1, for example, if there are no stream switches, and/or if there are switches between streams that use the same codec, operate with audio captured at the same sampling rate and same cut-off frequency, use same number of channels, and/or use the same tools and modes in the codec (e.g., no addition/removal of a SBR tool, use the same stereo coding mode, etc.).

For example, a stereo AAC stream at 128 Kbps may be utilized for high-quality reproduction. The stream may be reduced to approximately 64-80 Kbps for lower quality. In order to go to rates of 32-48 Kbps, a SBR tool (e.g. use HE-AAC), a switch to parametric stereo, etc. may be utilized.

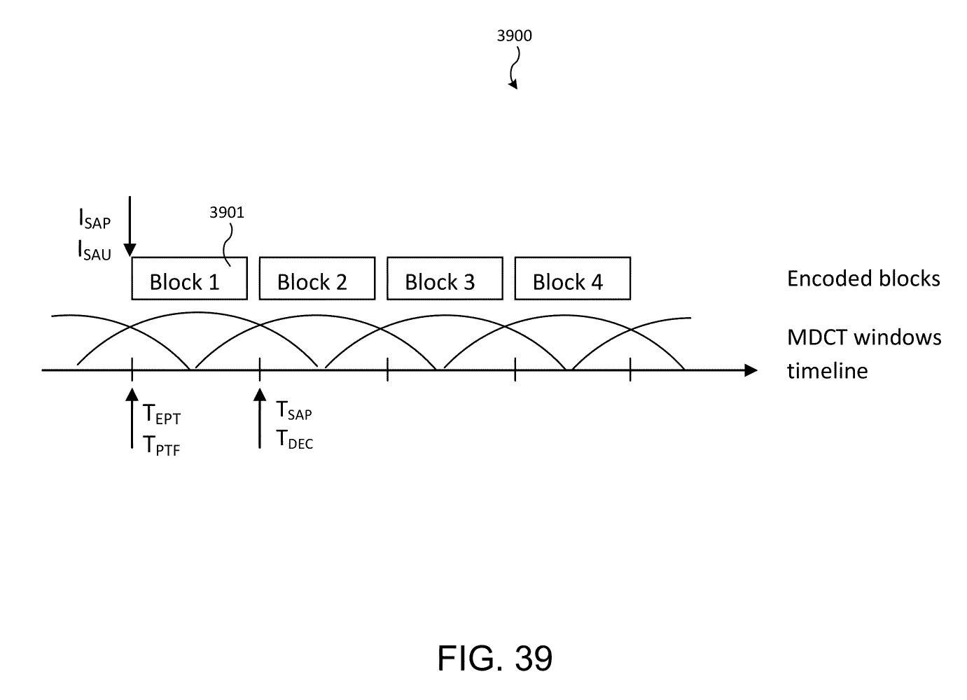

FIG. 39 is a diagram illustrating an example 3900 of an audio access point with a discardable block. One block 3901 at the beginning may be discarded (e.g., with AAC and MP3 audio codecs), for example, as shown in FIG. 39. For audio access points, the following may hold true: TEPT=TPTF<TSAP=TDEC. This may map to SAP type 4 in DASH, for example, as shown: TEPT<=TPFT<TDEC=TSAP.

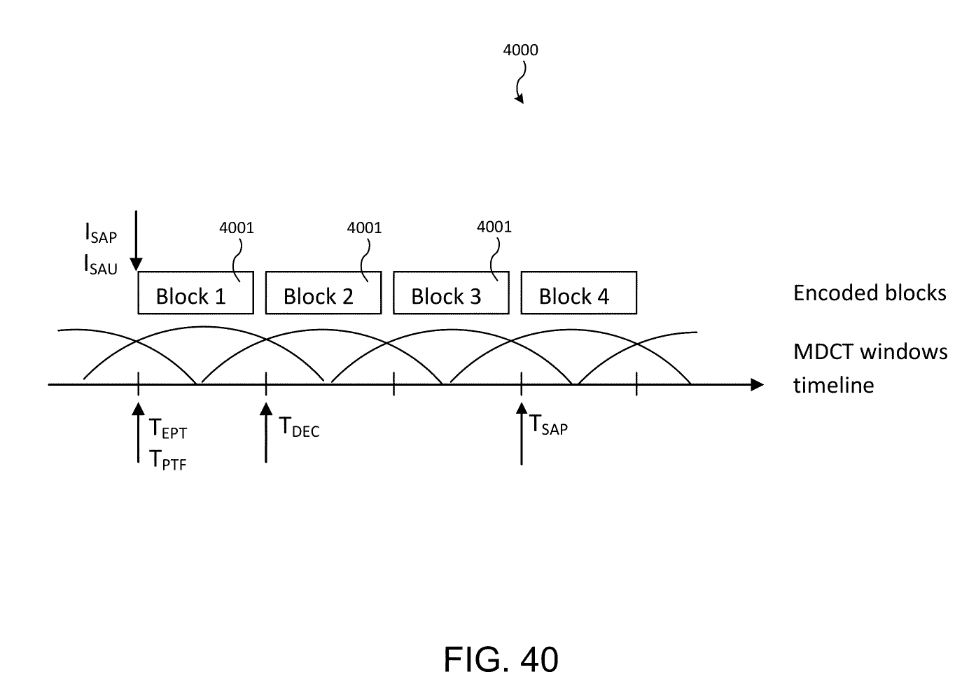

FIG. 40 is a diagram illustrating an example 4000 of an HE-ACC audio access point with three discardable blocks. A decoder may decode and discard more than one (e.g., three) leading blocks 4001. This may be performed for switches to an HE-AAC codec, wherein an AAC coder maybe operated at half the sampling rate and/or may utilize extra data to kick-in a SBR tool. For example, if three blocks 4001 are decoded and discarded, then the second and third blocks may be considered correctly decoded from the point of view of a core-AAC codec, but the TSAP may be set to a type 6 DASH SAP for full-spectrum reconstruction. For example, a type-6 SAP in DASH may be characterized by the following: TEPT<TDEC<TSAP, which may not be associated with a data type or means of using it.

SAP point declaration maybe utilized for switchable audio streams. For example, for MDCT-core AAC, Dolby AC3, and/or MP3 codecs, SAPs may be defined as SAP type 4 points. For example, for HE-AAC, AAC-ELD, MPEG Surround, MPEG SAOC, and/or MPEG USAC codecs, SAPs may be defined as SAP type 6 points. For example, for a new SAP type (e.g. SAP type “0”) may be defined for use with audio codec. The new SAP type may be characterized by the following: TEPT<=TPFT<TDEC<=TSAP. For example, if TDEC<TSAP, then an additional parameter may be utilized to define a distance between the points. For example, the use of a new SAP type (e.g., type 0) may not involve a change in profile, for example, since most profiles in DASH support SAPs of types <=3.

Seamless stream switching between audio streams may be implemented. If SAP types are defined correctly, a catenation of segments may not produce a best user experience during playback. Changes in codecs or sampling rates may manifest in clicks during playback. In order to avoid such clicks, a client (e.g., a DASH client) may implement a decode and/or a cross-fade operation, for example, similar those described above with reference to video switching.

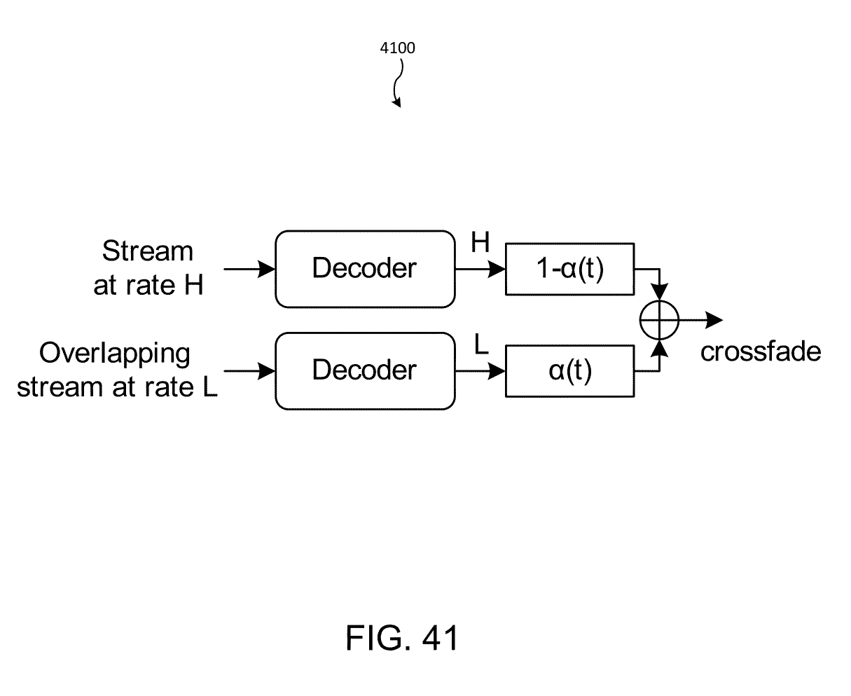

FIG. 41 is a diagram illustrating an example of a system 4100 for crossfading of audio streams in H-L transitions. The system 4100 of FIG. 41 may perform crossfading of audio over the H-to-L transition according to the following equation:

z=α(t)L+[1−α(t)]H.

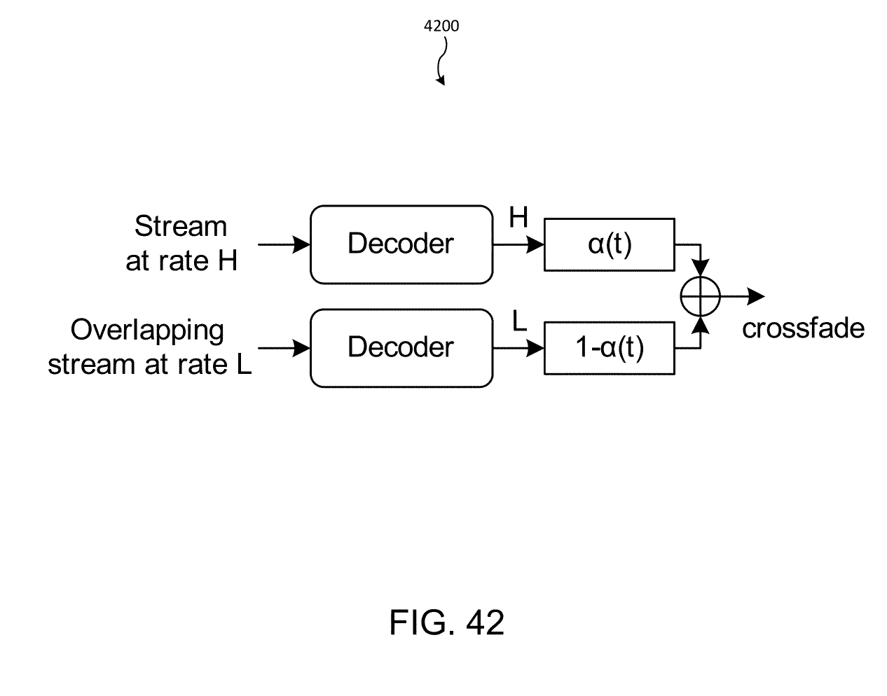

FIG. 42 is a diagram illustrating an example of a system 4200 for crossfading of audio streams in L-to-H transition. The system 4200 of FIG. 42 may perform crossfading of audio over the H-to-L transition according to the following equation:

z=α(t)H+[1−α(t)]L.

Although some of implementations are described above with reference to one of encoding or decoding, one of ordinary skill in the art will appreciate that the implementations may be utilized for both encoding and decoding streams of media content.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of performing smooth stream switching of media content, the method comprising:
receiving a first encoded data stream of the media content, the first encoded data stream characterized by a first signal-to-noise ratio (SNR);
receiving a second encoded data stream of the media content, the second encoded data stream characterized by a second SNR;
generating transition frames using at least one of frames of the first encoded data stream characterized by the first SNR and frames of the second encoded data stream characterized by the second SNR, the transition frames characterized by one or more SNR values that are between the first SNR and the second SNR.

2. The method of claim 1, further comprising:
displaying one or more frames of the first encoded data stream;
displaying the transition frames; and
displaying one or more frames of the second encoded data stream.

3. The method of claim 1, wherein generating the transition frames comprises:
crossfading the frames characterized by the first SNR with the frames characterized by the second SNR to generate the transition frames.

4. The method of claim 3, wherein crossfading comprises:
calculating a weighted average of the frames characterized by the first SNR and the frames characterized by the second SNR to generate the transition frames, wherein the weighted average changes over time.

5. The method of claim 3, wherein the transition frames are characterized by a transition time interval, and wherein crossfading comprises:
calculating a weighted average of the frames characterized by the first SNR and the frames characterized by the second SNR by applying a first weight to the frames characterized by the first SNR and a second weight to the frames characterized by the second SNR; and
wherein at least one of the first weight and the second weight changes over the transition time interval.

6. The method of claim 3, wherein the crossfading is performed using a linear transition between the first date stream and the second encoded data stream.

7. The method of claim 3, wherein the crossfading is performed using a non-linear transition between the first date stream and the second encoded data stream.

8. The method of claim 3, wherein the first encoded data stream and second encoded data stream comprise overlapping frames of the media content; and
wherein crossfading the frames characterized by the first SNR with the frames characterized by the second SNR to generate the transition frames comprises crossfading the overlapping frames of the first encoded data stream and the second encoded data stream to generate the transition frames.

9. The method of claim 8, wherein the overlapping frames are characterized by corresponding frames of the first encoded data stream and of the second encoded data stream, and wherein the overlapping frames are characterized by an overlap time interval.

10. The method of claim 9, further comprising:
displaying one or more frames of the first encoded data stream before the overlap time interval;
displaying the transition frames during the overlap time interval; and
displaying one or more frames of the second encoded data stream after the overlap time interval;
wherein the one or more frames of the first encoded data stream are characterized by times preceding the overlap time interval and the one or more frames of the second encoded data stream are characterized by times succeeding the overlap time interval.

11. The method of claim 3, further comprising:
transcoding a subset of frames of the first encoded data stream to generate corresponding frames characterized by the second SNR; and
wherein crossfading the frames characterized by the first SNR with the frames characterized by the second SNR to generate the transition frames comprises crossfading the subset of frames of the first encoded data stream with the corresponding frames characterized by the second SNR to generate the transition frames.

12. The method of claim 1, wherein the transition frames are characterized by a transition time interval, and wherein generating the transition frames comprises:
filtering the frames characterized by the first SNR using a low-pass filter characterized by a cutoff frequency that changes over the transition time interval to generate the transition frames.

13. The method of claim 1, wherein generating the transition frames comprises:
transforming and quantizing the frames characterized by the first SNR using one or more of step sizes to generate the transition frames.

14. The method of claim 1, wherein the first SNR is greater than the second SNR.

15. The method of claim 1, wherein the first SNR is less than the second SNR.

16. The method of claim 1, wherein the media content comprises video.

17. A wireless transmit/receive unit (WTRU) comprising:
a processor configured to:
receive a first encoded data stream of the media content, the first encoded data stream characterized by a first signal-to-noise ratio (SNR);
receive a second encoded data stream of the media content, the second encoded data stream characterized by a second SNR;
generate transition frames using at least one of frames of the first encoded data stream characterized by the first SNR and frames of the second encoded data stream characterized by the second SNR, the transition frames characterized by one or more SNR values that are between the first SNR and the second SNR.

18. The WTRU of claim 17, wherein the processor is further configured to:
display one or more frames of the first encoded data stream;
display the transition frames; and
display one or more frames of the second encoded data stream.

19. The WTRU of claim 17, wherein the processor configured to generate the transition frames comprises the processor configured to:
crossfade the frames characterized by the first SNR with the frames characterized by the second SNR to generate the transition frames.

20. The WTRU of claim 19, wherein the processor configured to crossfade the frames characterized by the first SNR with the frames characterized by the second SNR to generate the transition frames comprises the processor configured to:
calculate a weighted average of the frames characterized by the first SNR and the frames characterized by the second SNR to generate the transition frames, wherein the weighted average changes over time.

21. The WTRU of claim 19, wherein the transition frames are characterized by a transition time interval, and wherein the processor configured to crossfade the frames characterized by the first SNR with the frames characterized by the second SNR to generate the transition frames comprises the processor configured to:
calculate a weighted average of the frames characterized by the first SNR and the frames characterized by the second SNR by applying a first weight to the frames characterized by the first SNR and a second weight to the frames characterized by the second SNR; and
wherein at least one of the first weight and the second weight changes over the transition time interval.

22. The WTRU of claim 19, wherein the crossfade is performed using a linear transition between the first date stream and the second encoded data stream.

23. The WTRU of claim 19, wherein the crossfade is performed using a non-linear transition between the first date stream and the second encoded data stream.

24. The WTRU of claim 19, wherein the first encoded data stream and second encoded data stream comprise overlapping frames of the media content; and
wherein the processor configured to crossfade the frames characterized by the first SNR with the frames characterized by the second SNR to generate the transition frames comprises the processor configured to crossfade the overlapping frames of the first encoded data stream and the second encoded data stream to generate the transition frames.

25. The WTRU of claim 24, wherein the overlapping frames are characterized by corresponding frames of the first encoded data stream and of the second encoded data stream, and wherein the overlapping frames are characterized by an overlap time interval.

26. The WTRU of claim 25, wherein the processor is further configured to:
display one or more frames of the first encoded data stream before the overlap time interval;
display the transition frames during the overlap time interval; and
display one or more frames of the second encoded data stream after the overlap time interval;
wherein the one or more frames of the first encoded data stream are characterized by times preceding the overlap time interval and the one or more frames of the second encoded data stream are characterized by times succeeding the overlap time interval.

27. The WTRU of claim 19, wherein the processor is further configured to:
transcode a subset of frames of the first encoded data stream to generate corresponding frames characterized by the second SNR; and
wherein the processor configured to crossfade the frames characterized by the first SNR with the frames characterized by the second SNR to generate the transition frames comprises the processor configured to crossfade the subset of frames of the first encoded data stream with the corresponding frames characterized by the second SNR to generate the transition frames.

28. The WTRU of claim 17, wherein the transition frames are characterized by a transition time interval, and wherein the processor configured to generate the transition frames comprises the processor configured to:
filter the frames characterized by the first SNR using a low-pass filter characterized by a cutoff frequency that changes over the transition time interval to generate the transition frames.

29. The WTRU of claim 17, wherein the processor configured to generate the transition frames comprises the processor configured to:
transform and quantize the frames characterized by the first SNR using one or more of step sizes to generate the transition frames.

30. The WTRU of claim 17, wherein the first SNR is greater than the second SNR.

31. The WTRU of claim 17, wherein the first SNR is less than the second SNR.

32. The WTRU of claim 17, wherein the media content comprises video.
